(19) United States
(12) Patent Application Publication
(10) Pub. No.: US 2009/0077151 A1
(43) Pub. Date: Mar. 19, 2009

(54) Multi-Input, Multi-State Switching Functions and Multiplications

(76) Inventor: Peter Lablans, Morris Township, NJ (US)

Correspondence Address: DIEHL SERVILLA LLC, 77 BRANT AVE, SUITE 210, CLARK, NJ, 07066, US

(21) Appl. No.: 12/267,900

(22) Filed: Nov. 10, 2008

Related U.S. Application Data
(63) Continuation-in-part of application No. 11/018,956, filed on Dec. 20, 2004.
Application No. 11/018,956 is a continuation-in-part of application No. 11/679,316, filed on Feb. 27, 2007.
(60) Provisional application No. 60/987,240, filed on Nov. 12, 2007.

(51) Int. Cl. G06F 7/38

(52) U.S. Cl. 708/491

(57) ABSTRACT

Methods to create an implementation for a multi-input n-state logic function with at least one inverter at an input by modifying the truth table according to the inverter into a reduced truth table are provided. Implementations of the reduced truth table by gates and inverters are also disclosed. Applying reduced truth tables in n-state multiplications are also provided. N-state multiplications may be used in filters, Digital Signal Processing or in Linear Feedback Shift Registers (LFSRs). Using implementations of reduced truth tables in n-state multiplications are disclosed.

### STATEMENT OF RELATED CASES

This application is a continuation-in-part of U.S. patent application Ser. No. 11/018,956, filed on Dec. 20, 2004 and of U.S. patent application Ser. No. 11/679,316 filed on Feb. 27, 2007 which are both incorporated herein by reference. This application also claims the benefit of U.S. Provisional Patent Application Ser. No. 60/987,240, filed on Nov. 12, 2007, which is incorporated herein by reference in its entirety.

### BACKGROUND OF THE INVENTION

This invention relates to the implementation of multi-input (2 or more) functions such as multiplications in multi-valued logic and multi-state switching. More specifically it relates to calculating a multi-valued or radix-n product by determining partial products based on 2 or more inputs into multi-valued switching functions.

Current multipliers, for instance multipliers of a multi-digit variable with a multi-digit constant are pre-dominantly implemented in binary logic or by binary methods. The inventor has shown in U.S. patent application Ser. No. 11/018,956, filed on Dec. 20, 2004, which is incorporated herein by reference in its entirety how to implement multipliers in n-valued logic. The inventor has also shown in U.S. patent application Ser. No. 11/679,316 filed on Feb. 27, 2007 which is incorporated herein by reference in its entirety how to implement multi-input truth tables.

In multiplications, for instance with a multi-digit constant number, one may generate multiple partial products comprising at least one residue and often a carry. Each parallel logic step in calculating a partial product requires a clock pulse. It was shown that a radix-n partial product of a two input expression (a1*b1+a2*b2) wherein b1 and b2 are constant digits and comprising a residue and a possibly one or more carries may be implemented by replacing an n-valued addition with individual multipliers b1 and b2 at the input of the adder by modified n-valued logic functions having no multipliers at an input. This circumvents at least 2 clock pulses: one for multiplication and one for adding residues and carries.

After generating a partial product one still has to add the partial products to create a final product. It would reduce the number of clock pulses if one could generate a partial product from for instance 3 inputs such (a1*b1+a2*b2+a3*b3), or from 4 inputs such as (a1*b1+a2*b2+a3*b3+a4*b4) or from p inputs, assuming that b1, b2, etc are radix-n constants. Combining an additional input in a reduced n-valued switching function may substantially reduce the number of total switching cycles. This may lower clock rates and potentially power consumptions in applications such as digital filters and other digital signal processing applications.

Accordingly novel and improved methods and apparatus for implementing multi-valued logic functions for generating partial products from multiple inputs are required.

### SUMMARY OF THE INVENTION

In view of the more limited possibilities of the prior art, n-state switching logic for generating an output signal from multi-input signal methods and apparatus for processing binary and n-state symbols are provided in accordance with one aspect of the present invention. This will reduce the number of steps and possibly the number of components to generate said output which may be a product of an n-state multiplication.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Binary in the context of this application means 2-valued or 2-state. Multi-valued and multi-state or n-state and n-valued in the context of this invention means an integer greater than 2.

Aspects of the present invention are concerned with methods and circuits implementing n-valued or n-state switching functions with n>2. These devices may accept signals on one or more inputs, and generate a signal on one or more outputs. The functionality that is performed may be expressed as a radix-n arithmetical expression, for instance as (a1*b1+a2*b2+a3*b3). One is reminded that the expression requires the generation of a residue and a carry. Both carry and residue will require their own logic circuitry or implementation in n-state logic or in its binary representation.

An n-state switching function can be represented by a truth table. A truth table may be implemented in a true switching circuit or by a memory device that stores the states of the table and can provide the relevant states on an output. A state may be represented by a physical phenomenon such as a voltage or an optical intensity. Different states may then be represented by different voltages or intensities. States may be added to form a new state. States may also be represented by independent instances of a physical phenomenon. For instance, a state may be represented by a frequency of an electrical signal or optical signals with different wavelengths. States represented in this way cannot be added to form a new state.

In arithmetic the term radix-n is used for n-valued or modulo-n operations with n>2. For signals the term n-valued or n-state is used. A radix-n digit can be represented by for instance an n-valued or n-state signal. A radix-n digit can also be represented by a plurality of binary signals. In the present disclosure the term n-valued or n-state for a digit or for an arithmetical operation is intended to mean radix-n. The term n-state and n-valued are used in relation to signals and circuitry, though terms such as radix-n, n-state and n-valued may be used interchangeably.

In accordance with another aspect of the present invention a method is provided for physically generating an n-state symbol from an n-state logic function sc determined by a truth table having at least three inputs and at least one output, each of the inputs enabled to receive an n-state symbol and the at least one output enabled to provide an n-state symbol with n>3, at least one of the at least 3 inputs receiving an n-state symbol being modified by a n-state inverter comprising modifying the truth table of n-state function sc according to the n-state inverter into a new n-state truth table, implementing the new n-state truth table in an implementation having at least 3-inputs and one output and generating the n-state symbol on the one output of the implementation of the new n-state truth table.

In accordance with a further aspect of the present invention a method is provided, wherein an n-state function reflects an implementation of a mathematical rule in circuitry that can transform a signal.

In accordance with another aspect of the present invention a method is provided for physically generating an n-state symbol from an n-state logic function with a truth table, wherein the new state truth table implementation is applied in a digital filter.

In accordance with a further aspect of the present invention a method is provided for physically generating an n-state symbol from an n-state logic function with a truth table, wherein the new state truth table implementation is applied in a Digital Signal Processor.

In accordance with another aspect of the present invention a method is provided for physically generating an n-state symbol from an n-state logic function with a truth table wherein the new state truth table implementation is applied in a Linear Feedback Shift Register.

In accordance with a further aspect of the present invention a method is provided for physical implementation of an n-state logic function sc determined by a truth table having a plurality of at least three inputs and at least one output, each of the inputs enabled to receive an n-state symbol and the at least one output enabled to provide an n-state symbol with n≧3, at least one of the plurality at least 3 inputs receiving an n-state symbol being modified by a n-state inverter comprising an implementation of a new truth table, the implementation having the plurality of at least three inputs and at least one output, each of the inputs enabled to receive a signal representing an n-state symbol and the at least one output enabled to provide a signal representing an n-state symbol with n≧3, the new truth table created by including the step of modifying the truth table of n-state function sc according to the n-state inverter into the new n-state truth table.

In accordance with an aspect of the present invention a computer device is provided for performing a multiplication of a multiplicand of at least p radix-n digits with a multiplier of at least p radix-n digits with n≧2 and p≧3, comprising: a circuit having p inputs and an output, the circuit being selected from a plurality of circuits, the circuit implementing a truth table of a modulo-n addition that is modified in accordance with the p digits of the multiplier, wherein each of the p inputs is enabled to receive a signal that represents a radix-n digit of the multiplicand; none of the radix-n digits is zero; the output provides a signal that represents a residue of a sum of p partial products of the multiplication, each of the p partial products having an identical radix-n position and no signal representing a residue of a partial product is generated to determine the signal representing the residue of the sum; and means for selecting the circuit from the plurality of circuits based on a value of the p radix-n digits of the multiplier.

In accordance with yet a further aspect of the present invention the computer device that is provided further comprises a second circuit having p inputs and an output, wherein: the p inputs of the second circuit are enabled to receive the signals that represent the p radix-n digit of the multiplicand; the second circuit implements a truth table of a modulo-n addition carry in accordance with p digits of the multiplier; and the output of the second circuit provides a signal that represents a carry of the sum.

In accordance with yet a further aspect of the present invention the computer device is provided, wherein a signal representing a radix-n digit is an n-valued signal that is enabled to assume one of n states.

In accordance with yet a further aspect of the present invention the computer device is provided, wherein the first circuit is realized from at least one n-state switch.

In accordance with yet a further aspect of the present invention the computer device is provided, wherein a signal representing a radix-n digit is comprised of a plurality of binary signals.

In accordance with yet a further aspect of the present invention the computer device is provided, wherein the first circuit is realized from at least one binary switching component.

In accordance with yet a further aspect of the present invention the computer device is provided, wherein the device is applied in a digital filter.

In accordance with yet a further aspect of the present invention the computer device is provided, wherein the new state truth table implementation is applied in a Digital Signal Processor.

In accordance with another aspect of the present invention a computer device is provided for performing a multiplication of a variable multiplicand of at least p radix-n digits with a constant multiplier of at least p radix-n digits with n>2 and p≧3, comprising: a circuit having p inputs and an output, the circuit implementing a truth table of a modulo-n addition that is modified in accordance with p digits of the constant multiplier, wherein: each of the p inputs is enabled to receive a signal that represents a radix-n digit of the variable multiplicand; none of the p radix-n digits is zero; the output provides a signal that represents a residue of a sum of p partial products of the multiplication, each of the p partial products has an identical radix-n position and no signal representing a residue of a partial product is generated to determine the signal representing the residue of the sum.

In accordance with yet another aspect of the present invention the computer device further comprises a second circuit having p inputs and an output, wherein: the p inputs of the second circuit are enabled to receive the signals that represent the p radix-n digits of the multiplicand; the second circuit implements a truth table of a modulo-n addition carry in accordance with p digits of the multiplier; and the output of the second circuit provides a signal that represents a carry of the sum.

In accordance with yet another aspect of the present invention a computer device is provided, wherein a signal representing a radix-n digit is an n-valued signal that is enabled to assume one of n states.

In accordance with yet another aspect of the present invention a computer device is provided, wherein the circuit is realized from at least one n-state switch.

In accordance with yet another aspect of the present invention a computer device is provided, wherein a signal representing a radix-n digit is comprised of a plurality of binary signals.

In accordance with yet another aspect of the present invention a computer device is provided, wherein the circuit is realized from at least one binary switching component.

In accordance with yet another aspect of the present invention a computer device is provided, wherein the device is applied in a digital filter.

In accordance with a further aspect of the present invention a method is provided for performing with a computing device a multiplication of a variable multiplicand of at least p radix-n digits with a constant multiplier of at least p radix-n digits with n>2 and p≧3, comprising: inputting on each of p inputs of a circuit a signal representing a digit of the variable multiplicand, wherein the circuit implements a modulo-n addition modified in accordance with p radix-n digits of the constant multiplier and none of the p radix-n digits of the multiplicand and the multiplier is zero; outputting on an output of the circuit a signal that represents a residue of a sum of p partial products of the multiplication, each of the p partial products has an identical radix-n position and no signal representing a residue of a partial product is generated to determine the signal representing the residue of the sum.

In accordance with yet a further aspect of the present invention the method further comprises: inputting on p inputs of a second circuit the signals representing the digits of the variable multiplicand, wherein the second circuit implements a modulo-n addition carry truth table in accordance with p radix-n digits of the constant multiplier; outputting on an output of the second circuit a signal that represents a carry of the sum and no signal representing a residue of a partial product is generated to determine the signal representing the carry of the sum.

In accordance with yet a further aspect of the present invention a method is provided, wherein a signal representing a radix-n digit is an n-valued signal that is enabled to assume one of n states.

In accordance with yet a further aspect of the present invention a method is provided, wherein a signal representing a radix-n digit is comprised of a plurality of binary signals.

In accordance with yet a further aspect of the present invention a method is provided, wherein the multiplication is performed as part of implementing a digital filter.

### BRIEF DESCRIPTION OF THE DRAWINGS

Various other objects, features and attendant advantages of the present invention will become fully appreciated as the same becomes better understood when considered in conjunction with the accompanying drawings, and wherein:

FIG. 1 is a diagram illustrating a multi-input n-state logic function implementation;

FIG. 2 is a diagram illustrating a truth table of a 3-input logic function;

FIG. 3 is a diagram illustrating a 3-input 4-state adder;

FIG. 4a provides diagrams of n-state switches;

FIG. 4b illustrates an implementation of generating a residue of a 3-input, 4-state adder with gates and inverters;

FIG. 5 illustrates an Linear Feedback Shift Register (LFSR) based implementation;

FIG. 6 illustrates a reduced LFSR implementation in accordance with an aspect of the present invention;

FIG. 7 illustrates reduction of an implementation of a multi-input function with inverters to a single function implementation in accordance with an aspect of the present invention;

FIG. 8 provides a diagram of a 4-input circuit in accordance with an aspect of the present invention;

FIG. 9 is a diagram of an LFSR based circuit;

FIG. 10 is a diagram of an LFSR based circuit in accordance with an aspect of the present invention;

FIG. 11 is a diagram of an implementation of a multi-input switching function in accordance with an aspect of the present invention;

FIG. 12 is a diagram of an implementation of a multi-input switching function in accordance with an aspect of the present invention;

FIG. 13 is a diagram of a multi-input circuit in accordance with an aspect of the present invention;

FIG. 14 is a diagram of a multi-input circuit in accordance with an aspect of the present invention; and

FIG. 15 is a diagram of a multi-input circuit in accordance with an aspect of the present invention.

### DETAILED DESCRIPTION OF THE INVENTION

Aspects of the present invention provide novel implementation of n-valued with n>2 and/or binary logic functions for replacing a first n-valued logic function with 3 or more inputs that have inverters in at least one input and possible in all inputs, with an implementation of a single truth table, the single truth table being the first truth table that is modified in accordance with the multipliers at the input. It will be shown that one can modify the truth table, which usually is a p-dimensional truth table for a p-input function, of the function by another truth table that is modified according to the inverters at the inputs. Such reduction of n-valued truth tables can, as in the 2-input case, be applied to any n-valued truth table of functions with p inputs. Immediate application can be applied to evaluating a p-input radix-n partial product (a1b1+a2*b2+a3*b3+ . . . ap*bp) wherein a1 a2 a3 . . . ap are n-valued variable digits in a radix-n number and b1 . . . bp are constant digits in a constant radix-n number.

An example may demonstrate the need for multi-input function reduction. Assume the variable radix-n numbers d0 . . . d1d2d3 . . . dp wherein the digits d1, d2 and d3, etc are part of the multiplicand and the constant radix-n number c0 . . . c1c2c3 . . . cp wherein the digits c1, c2 and c3, etc are part of the multiplier. Part of the multiplication is:

. . . d1 d2 d3 . . .
. . . c1 c2 c3 . . .
. . . d1c3 d2c3 d3c3 . . .
. . . d1c2 d2c2 d3c2 . . .
. . . d1c1 d2c1 d3c1 . . .

One partial product in the above multiplication is d1c3; another partial product is d2c2 and yet another partial product is d3c1. One may determine all individual partial products and add these. In accordance with the earlier cited patent application one may determine (d1c3+d2c2) by applying reduced n-valued logic functions. However one has at least to determine the sum of the partial products (d1c3+d2c2+d3c1) to determine the final product. Accordingly it would be an improvement in clock cycles if one could determine residue and carry of (d1c3+d2c2+d3c1) in one step rather than for instance first determining residue and carry or carries of (d1c3+d2c2), followed by determining d3c1 and then adding the result of (d1c3+d2c2) and d3c1.

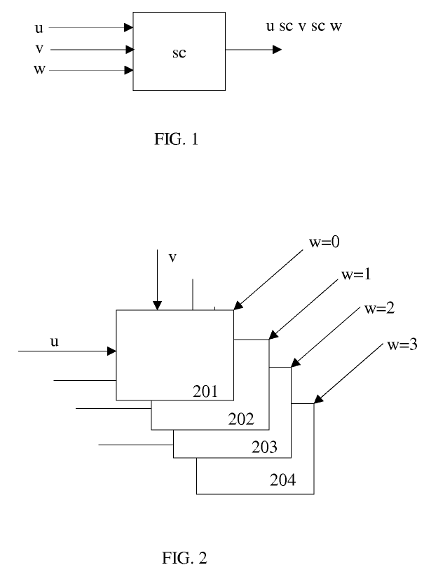

The determination of the truth table of a p-input n-valued addition is fairly easy to achieve. For instance a 3-input modulo-4 adder will require a 4 by 4 by 4 truth table. A diagram of such an adder is shown in FIG. 1 and a diagram of the corresponding truth table in FIG. 2 in 201, 202, 203 and 204. The adder has three inputs providing signals representing 4-valued digits u, v and w executing the expression (u sc v sc w), wherein sc is the modulo-4 adder. This function is commutative and associative. A construction of the truth table can be performed in the following way: construct a partial truth table (u sc v) sc 0; then construct (u sc v) sc 1; then construct (u sc v) sc 2; and finally construct (u sc v) sc 3. Accordingly a 4-valued 3-input function will have a 4 by 4 by 4 or a (4)³ truth table. And a n-valued p-input function will have a (n)^{p} truth table.

The truth table for the 3-input 4-valued modulo-4 adder is then:

| | 0 | 1 | 2 | 3 |
|---|---|---|---|---|
| w = 0 | | | | |
| 0 | 0 | 1 | 2 | 3 |
| 1 | 1 | 2 | 3 | 0 |
| 2 | 2 | 3 | 0 | 1 |
| 3 | 3 | 0 | 1 | 2 |
| w = 1 | | | | |
| 0 | 1 | 2 | 3 | 0 |
| 1 | 2 | 3 | 0 | 1 |
| 2 | 3 | 0 | 1 | 2 |
| 3 | 0 | 1 | 2 | 3 |
| w = 2 | | | | |
| 0 | 2 | 3 | 0 | 1 |
| 1 | 3 | 0 | 1 | 2 |
| 2 | 0 | 1 | 2 | 3 |
| 3 | 1 | 2 | 3 | 0 |
| w = 3 | | | | |
| 0 | 3 | 0 | 1 | 2 |
| 1 | 0 | 1 | 2 | 3 |
| 2 | 1 | 2 | 3 | 0 |
| 3 | 2 | 3 | 0 | 1 |

As was pointed out earlier in the cited patent application the partial truth tables are a permutation or re-shuffle of the first truth table with w=0 in accordance with inverters.

One can also determine the truth table of a carry for a 3-input 4-valued addition. The carry truth table is provided in the following tables.

The truth table for the 3-input 4-valued carry related to a modulo-4 adder is then:

| | 0 | 1 | 2 | 3 |
|---|---|---|---|---|
| w = 0 | | | | |
| 0 | 0 | 0 | 0 | 0 |
| 1 | 0 | 0 | 0 | 1 |
| 2 | 0 | 0 | 1 | 1 |
| 3 | 0 | 1 | 1 | 1 |
| w = 1 | | | | |
| 0 | 0 | 0 | 0 | 0 |
| 1 | 0 | 0 | 1 | 1 |
| 2 | 0 | 1 | 1 | 1 |
| 3 | 0 | 1 | 1 | 1 |
| w = 2 | 0 | | | |
| 0 | 0 | 0 | 1 | 1 |
| 1 | 0 | 1 | 1 | 1 |
| 2 | 1 | 1 | 1 | 1 |
| 3 | 1 | 1 | 1 | 2 |
| w = 3 | | | | |
| 0 | 0 | 1 | 1 | 1 |
| 1 | 1 | 1 | 1 | 1 |
| 2 | 1 | 1 | 1 | 2 |
| 3 | 1 | 1 | 2 | 2 |

The 3-input truth tables of the carry are not a re-shuffle of each other.

There are different ways to implement the above truth tables as has been shown for instance by the inventor in U.S. Pat. No. 7,218,144 issued on May 15, 2007 which is incorporated herein by reference in its entirety. One way is to store states of a truth table in a memory wherein the input states form an input address that will identify the appropriate output state. The input and output states may be processed in binary form. They may be transformed from n-valued to binary by an A/D converter and from binary to n-valued signals by a D/A converter for example.

One should keep in mind that when one combines more inputs in (a1+a2+a3+ . . . ap) then additional carries will need to be generated. For instance 5 4-valued inputs in a straight forward addition can maximally be 15 which is [3 3] in radix-4 notation. However when 6 digits are combined in a 6-input implementation the result can be 18 which is [1 0 2] in radix-4 and requires an additional carry. This does not change the fundamental approach, but it should be kept in mind when combining a number of inputs.

For calculating (a1b1+a2*b2+a3*b3) wherein b1, b2 and b3 are n-valued constants and a1, a2 and a3 are radix-n variables, each representing a single radix-n digit, each digit being represented by an n-valued signal, or by a plurality of p-valued signals with p<n, one has to determine the truth table for the residue and for the carry. In the known conventional way one would first calculate the individual partial products like a1 b1 in residue and carry and then add the residues and carries of all the partial products, usually by applying a ripple adder.

In accordance with one aspect of the present invention all individual multipliers will be eliminated in determining residue and carries in an n-valued expression (a1b1+a2*b2+ . . . ap*bp) by providing implementations of p-input n-valued truth tables. The implementation of n-valued truth tables has already been demonstrated in cited U.S. Pat. No. 7,218,144 and patent application Ser. No. 11/679,316. A next step is to provide equivalent truth tables that will eliminate multipliers in the residue calculation and will generate the required residue and carries. In fact no intermediate products or results have to be determined. Implemented truth tables provide directly a residue and a carry of a multi-input (more than 2) multiplication.

A 4-Valued/State Example

To demonstrate the multiplier reduction a 4-valued 3-input example will be provided.

First of all the maximum result of a1b1+a2*b2+a3*b3 in 4-valued logic is 3*3+3*3+3*3=27. This is [1 2 3] in radix-4 notation. This means that one may have to determine one residue and two different carries depending on the value of b1, b2 and b3. Each combination of b1, b2 and b3 will generate its own truth table. For smaller values of b1, b2 and b3, for instance when [b1 b2 b3]=[1 1 0] one only has to generate 1 residue and one carry. Further more one can re-use implementations of configurations that may be considered permutations of each other by switching inputs. For instance a configuration with b1=1, b2=0 and b3=1 may use the implementation of b1=1, b2=1 and b3=0 with input a2 switched with a3.

As an example the 4-valued truth tables will be provided for residue and carries for the configuration: b1=1, b2=2 and b3=3. The maximum possible value generated by 4-valued expression (a1+a2*2+a3*3) is 3+6+9=18, which is [1 0 2] in radix-4 notation. So this requires generating one residue and two carries. One may generate the truth tables automatically by fairly simple computer programs.

The 4 tables for the 3-input adder residue with b1=1, b2=2 and b3=3 are:

| | 0 | 1 | 2 | 3 |
|---|---|---|---|---|
| a3 = 0 | | | | |
| 0 | 0 | 2 | 0 | 2 |
| 1 | 1 | 3 | 1 | 3 |
| 2 | 2 | 0 | 2 | 0 |
| 3 | 3 | 1 | 3 | 1 |
| a3 = 1 | 0 | | | |
| 0 | 3 | 1 | 3 | 1 |
| 1 | 0 | 2 | 0 | 2 |
| 2 | 1 | 3 | 1 | 3 |
| 3 | 2 | 0 | 2 | 0 |
| a3 = 2 | | | | |
| 0 | 2 | 0 | 2 | 0 |
| 1 | 3 | 1 | 3 | 1 |
| 2 | 0 | 2 | 0 | 2 |
| 3 | 1 | 3 | 1 | 3 |
| a3 = 3 | 0 | | | |
| 0 | 1 | 3 | 1 | 3 |
| 1 | 2 | 0 | 2 | 0 |
| 2 | 3 | 1 | 3 | 1 |
| 3 | 0 | 2 | 0 | 2 |

A diagram of a 3-input 4-valued or 4-state adder is provider in FIG. 3 which shows that a residue, a first carry and a second carry will be generated.

The truth table for the 3-input 4-valued first carry related to a modulo-4 adder with b1=1, b2=2 and b3=3 is provided by the 4 tables:

| | 0 | 1 | 2 | 3 |
|---|---|---|---|---|
| a3 = 0 | | | | |
| 0 | 0 | 0 | 1 | 1 |
| 1 | 0 | 0 | 1 | 1 |
| 2 | 0 | 1 | 1 | 2 |
| 3 | 0 | 1 | 1 | 2 |
| a3 = 1 | | | | |
| 0 | 0 | 1 | 1 | 2 |
| 1 | 1 | 1 | 2 | 2 |
| 2 | 1 | 1 | 2 | 2 |
| 3 | 1 | 2 | 2 | 3 |
| a3 = 2 | | | | |
| 0 | 1 | 2 | 2 | 3 |
| 1 | 1 | 2 | 2 | 3 |
| 2 | 2 | 2 | 3 | 3 |
| 3 | 2 | 2 | 3 | 3 |
| a3 = 3 | | | | |
| 0 | 2 | 2 | 3 | 3 |
| 1 | 2 | 3 | 3 | 0 |
| 2 | 2 | 3 | 3 | 0 |
| 3 | 3 | 3 | 0 | 0 |

The truth table for the 3-input 4-valued second carry related to a modulo-4 adder with b1=1, b2=2 and b3=3 is provided by the 4 tables:

| | 0 | 1 | 2 | 3 |
|---|---|---|---|---|
| a3 = 0 | | | | |
| 0 | 0 | 0 | 0 | 0 |
| 1 | 0 | 0 | 0 | 0 |
| 2 | 0 | 0 | 0 | 0 |
| 3 | 0 | 0 | 0 | 0 |
| a3 = 1 | | | | |
| 0 | 0 | 0 | 0 | 0 |
| 1 | 0 | 0 | 0 | 0 |
| 2 | 0 | 0 | 0 | 0 |
| 3 | 0 | 0 | 0 | 0 |
| a3 = 2 | | | | |
| 0 | 0 | 0 | 0 | 0 |
| 1 | 0 | 0 | 0 | 0 |
| 2 | 0 | 0 | 0 | 0 |
| 3 | 0 | 0 | 0 | 0 |
| a3 = 3 | | | | |
| 0 | 0 | 0 | 0 | 0 |
| 1 | 0 | 0 | 0 | 1 |
| 2 | 0 | 0 | 0 | 1 |
| 3 | 0 | 0 | 1 | 1 |

One can check the tables for all the required inputs. As an example calculate a1+a2*2+a3*3 for a1=2, a2=3 and a3=3. This will generate 2+3*2+3*3=17. The result 17 in radix-4 is [1 0 1] which is in agreement with the truth tables.

The dimensions of each table and the number of tables is determined by n=4. The input p=3 determines the dimensions of the truth table (a1, a2, a3).

### General Multi-Valued Multiplication

The above approach can be applied to any n-valued formula (a1b1+a2*b2+ . . . ap*bp). As was shown above a multiplication of n-valued variable multiplicand v1v2v3v4 . . . vk wherein v1, . . . vk are each an n-valued digit with an n-valued constant multiplier c1c2c3c4 . . . cm wherein c1, . . . cm are each an n-valued digit will have partial products of the form: vᵢcᵢ₊ⱼ+vᵢ₊₁cᵢ₊ⱼ₋₁₊ᵥᵢ+2cᵢ₊ⱼ₋₂ . . . . One can then combine a set of partial products without actually determining these partial products by considering such a set as a multi-input, n-valued operation as explained above, generating residue and carries. Thus one can drastically limit the number of cycles in determining a product of an n-valued variable with an n-valued constant each containing multiple digits.

Rather than determining multiple partial products one determines in one operation a single partial product-sum. As shown in earlier cited patent applications one may when appropriate further combine the partial products by n-valued Carry Save Additions (CSA). In final calculations one may also apply n-valued Carry Look Ahead operations to limit carry ripple effects.

The multiplication of multi-digit n-valued variables with multi-digit n-valued constants may take place in Digital Signal Processing (DSP) such as in Finite Impulse Response (FIR) or other digital filters and DSP applications. Moving from binary to n-valued logic may already reduce the number of clock cycles. Using the multi-input approach may further limit the required number of clock cycles and make a DSP application much faster at a set clock rate or make the DSP application possible at a lower internal clock-rate while meeting the required Nyquist sampling rate. Such DSP application may be applied in communication systems. The communication system may be a wireless communication system. The DSP application using reduced multiplication methods may also be applied in radar.

Another application of multi-digit multiplications may be in digital imaging. For instance high definition imaging may use pixels which are coded in 8 or more bits. Filtering or other DSP application may run into binary multiplications as a severe bottleneck. Using multi-state switching as well as multi-input multipliers may reduce the symbol throughput.

The multi-input n-valued logic operation was illustrated above by additions involving a carry. Such an operation is also fully contemplated for subtractions for instance as part of a division of a multi-digit n-valued variable by multi-digit n-valued constant. Herein (instead of carries) one has to apply “borrow” digits.

In a further example one may use a reversible n-valued logic function with multi-inputs. One may further provide those inputs with n-valued reversible inverters. One may then reduce the multi-input with inverters n-valued logic function to an n-valued multi-input function with no inverters. One may also create the reversing function.

As an example the 4-valued addition over GF(2²) will be used. Its truth table of a 2-input function is provided in the following table.

| addgf4 | 0 | 1 | 2 | 3 |
|---|---|---|---|---|
| 0 | 0 | 1 | 2 | 3 |
| 1 | 1 | 0 | 3 | 2 |
| 2 | 2 | 3 | 0 | 1 |
| 3 | 3 | 2 | 1 | 0 |

The truth table of the 3-input truth table is provided below. It can be determined from the expression: out=(a1 addgf4 a2 addgf4 a3). The function addgf4 is associative and commutative.

| | 0 | 1 | 2 | 3 |
|---|---|---|---|---|
| a3 = 0 | | | | |
| 0 | 0 | 1 | 2 | 3 |
| 1 | 1 | 0 | 3 | 2 |
| 2 | 2 | 3 | 0 | 1 |
| 3 | 3 | 2 | 1 | 0 |
| a3 = 1 | | | | |
| 0 | 1 | 0 | 3 | 2 |
| 1 | 0 | 1 | 2 | 3 |
| 2 | 3 | 2 | 1 | 0 |
| 3 | 2 | 3 | 0 | 1 |
| a3 = 2 | | | | |
| 0 | 2 | 3 | 0 | 1 |
| 1 | 3 | 2 | 1 | 0 |
| 2 | 0 | 1 | 2 | 3 |
| 3 | 1 | 0 | 3 | 2 |
| a3 = 3 | | | | |
| 0 | 3 | 2 | 1 | 0 |
| 1 | 2 | 3 | 0 | 1 |
| 2 | 1 | 0 | 3 | 2 |
| 3 | 0 | 1 | 2 | 3 |

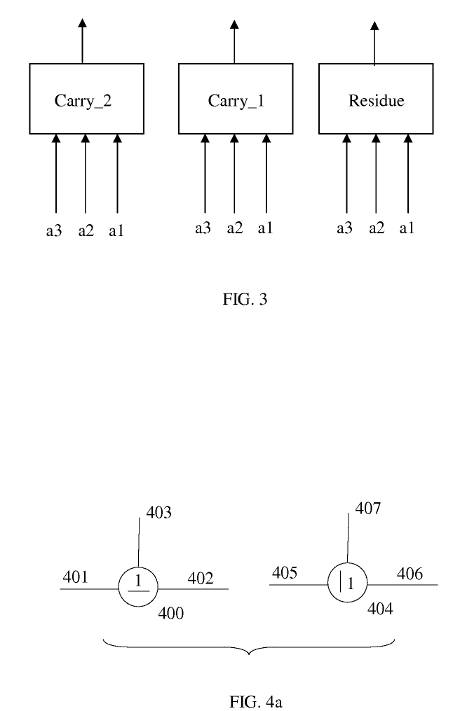

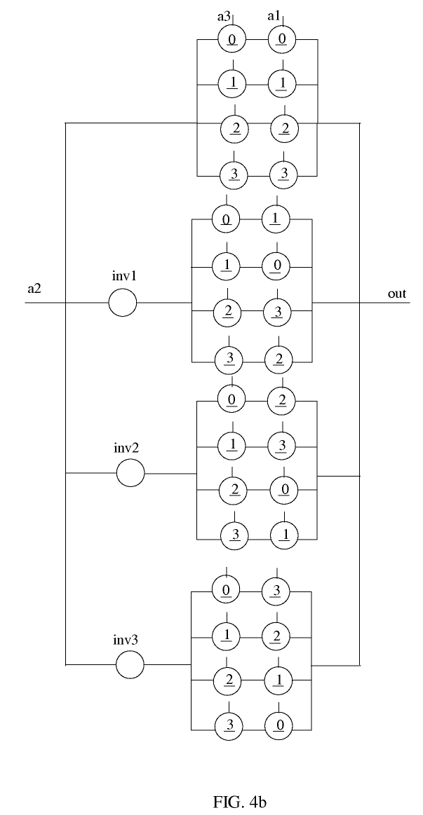

All the tables of the above truth table can be realized with inverters [0 1 2 3] (identity); [1 0 3 2]; [2 3 0 1]; and [3 2 1 0] and with 4-valued switches controlled by a1 or by a2 or by a3. One such switch is illustrated in FIG. 4a. The switch has a body 400 with a first input 401 and output 402 and a control input 403. The diagram of 400 has a horizontal line with the number 1. The horizontal line means that the state of the output 402 will be identical to the state of the input 401, whenever the state of control input 403 is the same as the state of the number provided above the line. In this case that is state 1. Furthermore, the state of the output 402 will be equivalent to the state represented by absence of signal, whenever the state of the control output is not identical to the state represented by the number above the horizontal line. In a further embodiment, one may have the state of the output 402 identical to a designated state for instance state 0, whenever the state of the control input 403 does not have the state represented by the number above the horizontal line. Switch 404 in FIG. 4a provides the state of input 405 on output 406, whenever the state of control input 407 is not identical to the state represented by the number to the right of the vertical line inside the symbol for the switch. Whenever the state of control input 407 is identical to the number to the right of the vertical line the state of 406 is identical to the state represented by absence of signal. In a further embodiment in that situation the state can also be a pre-designated state such as for instance state 0.

A possible implementation using switches in accordance with 400 of FIG. 4a is shown in FIG. 4b using inverters inv1=[1 0 3 2]; inv2=[2 3 0 1] and inv3=[3 2 1 0].

In FIG. 4b the path of the symbol a2 to be processed is determined by a1 and a2. One can see that when a1=0 and a3=0 then a2 ‘sees’ the identity [0 1 2 3] and a2 will not be modified and provided on output ‘out’. The components of FIG. 4 may be re-arranged to save on the total number of components.

One may then summarize a method of creating an p-input, n-state or n-valued switching function with p>2 and n>2 of which at least one input has an n-state inverter from a 2-input n-state switching function representing a mathematical rule with a truth table by:

1. modifying the truth table of the 2-input truth table to a p-input truth table; and
2. modifying the p-input truth table in accordance with the n-state inverter

The mathematical rule may be any rule that translates a value into a state. This may include but is not limited to for instance modulo-n addition residue or carry; modulo-n multiplication residue or carry; modulo-n division residue or carry; modulo-n greater than; modulo-n maximum, addition, multiplication, division over GF(n) or any other rule that can be expressed in a n-state switching table.

One may thus also implement any n-state function with p-inputs. Furthermore, one may thus implement any n-state function with p inputs and at least one inverter which may be or may not be a reversible inverter. Clearly an n-state p-input carry function is a non-reversible function.

Once a p-input n-state truth table is established, be it on the basis of a mathematical rule or any other way, one may modify a truth table of a function with at least an n-state inverter at one input in accordance with the n-state inverter as was shown above.

One can then implement the truth table for instance by using n-state switches and inverters as was shown in FIG. 4b.

Herein the terms multi-valued and multi-state are used interchangeably. In binary logic one tends to call the states of 0 and 1 and provide the state with a level or value. This usually is extended to multi-state switching wherein more than 2 states are used. Especially in electronic switching one may use a signal such as a voltage to represent a state or for instance an optical intensity. The states are thus connected to a level or value of a signal, which in turn leads to calling the multi-state switching or logic being multi-valued. However what is called a value is not inherently identical to a state. One may assign a value to a state, but that is not required. Further more a state does not have to be represented by a level of a physical phenomenon. A state may also be a presence of a characteristic of a phenomenon. For instance rather that being represented by a voltage level a state may be represented by a frequency of a signal as is known in FSK signaling. Or a state may be represented by a wavelength of light, or by the presence of a material.

Accordingly, state and value and multi-state and multi-valued or n-state and n-valued may be used interchangeably, and are intended to mean the same. Also the terms switching and logic are intended to mean the same herein.

Furthermore, one generally uses electrical circuits for binary and multi-state switching. However, such a limitation is not provided here. Herein, multi-state switching may be performed by any physical phenomenon that can appear in two or more states. It may be electrical, optical, mechanical, quantum-mechanical, chemical, biological or any other appearance of a phenomenon that has 2 or more states. Furthermore, a difference in state may be provided by a difference in intensity or level of amplitude. However, such differences may also be other characteristics in a natural phenomenon and may include but are not limited to voltage, current, charge, intensity, mass, impulse, spin, energy, quantum-mechanical state, polarization, orientation in an electromagnetic field, frequency, wave-length, or any other characteristic of a phenomenon that can represent two or more states.

These aspects may involve the frequency or the phase of a signal. They may also involve electronic spin, wavelength, ionization level, polarization, position, duration, direction, presence of a molecule or an atom or ion, refraction angle or any physical phenomenon that can be detected as being meaningful present or absent within occurring environmental noise levels. For instance a presence of a certain protein may signify an occurring logic state.

While it was shown that an n-state logic or switching functions may be implemented with n-state switching components, it is also fully contemplated that the n-state functions may be implemented in binary technology. All states of an n-state truth table may be implemented in binary logic having inputs that provide binary signals and outputs that generate binary signals. A word of binary signals may thus represent a non-binary symbol. For instance 2 bits may represent a 4-state symbol. A word of 3 bits may be used to represent a 5-state symbol. It may also be used to represent an 8-state symbol, to be processed by a binary circuit. One may apply an Analog/Digital converter to convert an n-state symbol having discrete states into a binary word. One may use a Digital/Analog converter to convert a binary word into an analog signal having discrete states.

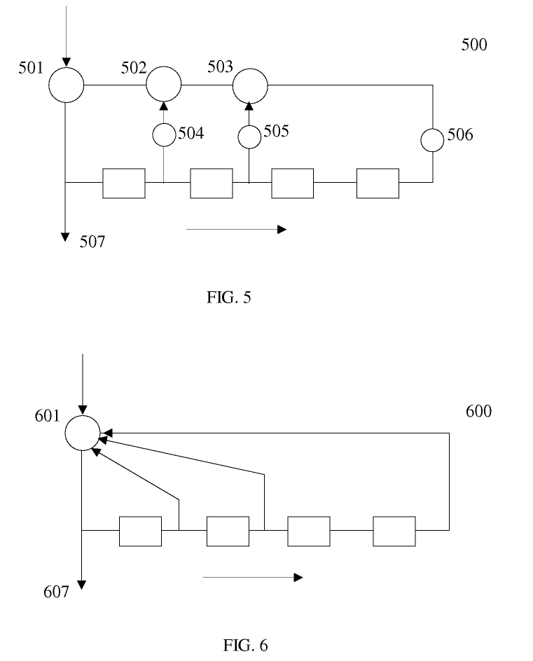

One example herein provided applies to multiplication. A multi-input multiplication may be used in for instance a digital filter. However, a multi-input multiplication may also be used in for instance an n-state Linear Feedback Shift Register application in for instance Fibonacci configuration. An example is shown in FIG. 5. FIG. 5 shows a 4-element Linear Feedback Shift Register (LFSR) scrambler with two taps in Fibonacci configuration. Assume that the functions 501, 502 and 503 are identical functions for instance additions over GF(n). One may reduce different 2-input n-state functions to a single multi-input n-state function. However in LFSR circuits one usually applies additions over GF(n) with multipliers such as 504, 505 and 506. One may reduce the 3 2-input functions 501, 502 and 503 which are all additions over GF(n) to a single 4-input n-state addition over GF(n) and modify the truth table thereof according to n-state multipliers (or inverters) 504, 505 and 506, which will then create a single 4-input function 601 as shown in FIG. 6. This reduced LFSR as shown in FIG. 6 provides at its output 607 the same symbol as in FIG. 5 at output 507. Because all functions and inverters herein are reversible function 601 can be implemented with just one inverter in a switching path. Accordingly the Fibonacci LFSR has been reduced to an almost single step LFSR which may be close to the performance of a Galois LFSR.

One may use as an example an adder over GF(3) with the following truth table.

| | 0 | 1 | 2 |
|---|---|---|---|
| 0 | 0 | 1 | 2 |
| 1 | 1 | 2 | 0 |
| 2 | 2 | 0 | 1 |

Without multipliers in the inputs, a 3-input adder over GF(3), which is the standard modulo-3 adder, may be characterized by the equation d=(a sc3 b sc3 c) and has the following truth tables.

| | | a | | |
|---|---|---|---|---|
| sc3 | | 0 | 1 | 2 |
| | c = 0 | | | 2 |
| b | 0 | 0 | 1 | 2 |
| | 1 | 1 | 2 | 0 |
| | 2 | 2 | 0 | 1 |
| | c = 1 | | | |
| b | 0 | 1 | 2 | 0 |
| | 1 | 2 | 0 | 1 |
| | 2 | 0 | 1 | 2 |
| | c = 2 | | | |
| b | 0 | 2 | 0 | 1 |
| | 1 | 0 | 1 | 2 |
| | 2 | 1 | 2 | 0 |

One may insert in the input of b for this function the radix-3 multiplier 2 which is the 3-valued inverter [0 2 1]. One may replace the function add GF(3) with a multiplier 2 at the input for b with a 3-valued function sc31 which has no multipliers or inverters but realizes the same function sc3 with the specific multiplier. The truth table of this function is provided in the following tables.

| | | a | | |
|---|---|---|---|---|
| sc31 | | 0 | 1 | 2 |
| | c = 0 | | | |
| b | 0 | 0 | 2 | 1 |
| | 1 | 1 | 0 | 2 |
| | 2 | 2 | 1 | 0 |
| | c = 1 | | | |
| b | 0 | 1 | 0 | 2 |
| | 1 | 2 | 1 | 0 |
| | 2 | 0 | 2 | 1 |
| | c = 2 | | | |
| b | 0 | 2 | 1 | 0 |
| | 1 | 0 | 2 | 1 |
| | 2 | 1 | 0 | 2 |

One can easily check that the truth table of sc31 can be derived by modifying the truth table of sc3 in accordance with the multiplier or inverter [0 2 1] over the dimension that is determined by input b. That dimension in this case determines the rows in each of the individual tables. The inverter [0 2 1] leaves the first row unmodified and the second row is switched with the third row.

The reduction and truth table modification is again demonstrated in FIG. 7. FIG. 7 shows a device 700 having 4 inputs: 701, 703, 704 and 705 and output 702. Assume 700 implements a 4-input function sc4 with input 703 receiving a signal representing variable v modified by inverter inv1 (706), input 705 receiving a signal representing variable x modified by inverter inv2 (707), input 701 receiving a signal representing variable u, and input 704 receiving a signal representing variable w. Assume output 702 provides a signal representing a signal out. The output signal ‘out’ can be expressed as: out=(u sc4 inv1(v) sc4 w sc4 inv2(x)).

How to read or resolve such an expression is determined by the truth table of the function sc4. If sc4 is associative then the order of execution does not matter. Otherwise it does. Furthermore, using inverters that are not multipliers over GF(n) will in general make the reduced function non-associative. Assume the function sc4 to be determined by the following 2-input 4-valued truth table.

| | a | | | | |
|---|---|---|---|---|---|
| sc4 | | 0 | 1 | 2 | 3 |
| b | 0 | 0 | 1 | 2 | 3 |
| | 1 | 1 | 0 | 3 | 2 |
| | 2 | 2 | 3 | 0 | 1 |
| | 3 | 3 | 2 | 1 | 0 |

The basic function sc4 is an associative function. The complete truth table for a 4-input function based on sc4 is provided in the following tables.

| c = 0, | | | b | | | c = 0, | | | b | | c = 0, | | | b | | c = 0, | | | b | |
|---|---|---|---|---|---|---|---|---|---|---|---|---|---|---|---|---|---|---|---|---|
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 0 | 1 | 2 | 3 | | 1 | 0 | 3 | 2 | | 2 | 3 | 0 | 1 | | 3 | 2 | 1 | 0 |
| | 1 | 1 | 0 | 3 | 2 | | 0 | 1 | 2 | 3 | | 3 | 2 | 1 | 0 | | 2 | 3 | 0 | 1 |
| | 2 | 2 | 3 | 0 | 1 | | 3 | 2 | 1 | 0 | | 0 | 1 | 2 | 3 | | 1 | 0 | 3 | 2 |
| | 3 | 3 | 2 | 1 | 0 | | 2 | 3 | 0 | 1 | | 1 | 0 | 3 | 2 | | 0 | 1 | 2 | 3 |
| c = 1, | | | b | | | c = 1, | | | b | | c = 1, | | | b | | c = 1, | | | b | |
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 1 | 0 | 3 | 2 | | 0 | 1 | 2 | 3 | | 3 | 2 | 1 | 0 | | 2 | 3 | 0 | 1 |
| | 1 | 0 | 1 | 2 | 3 | | 1 | 0 | 3 | 2 | | 2 | 3 | 0 | 1 | | 3 | 2 | 1 | 0 |
| | 2 | 3 | 2 | 1 | 0 | | 2 | 3 | 0 | 1 | | 1 | 0 | 3 | 2 | | 0 | 1 | 2 | 3 |
| | 3 | 2 | 3 | 0 | 1 | | 3 | 2 | 1 | 0 | | 0 | 1 | 2 | 3 | | 1 | 0 | 3 | 2 |
| c = 2, | | | b | | | c = 2, | | | b | | c = 2, | | | b | | c = 2, | | | b | |
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 2 | 3 | 0 | 1 | | 3 | 2 | 1 | 0 | | 0 | 1 | 2 | 3 | | 1 | 0 | 3 | 2 |
| | 1 | 3 | 2 | 1 | 0 | | 2 | 3 | 0 | 1 | | 1 | 0 | 3 | 2 | | 0 | 1 | 2 | 3 |
| | 2 | 0 | 1 | 2 | 3 | | 1 | 0 | 3 | 2 | | 2 | 3 | 0 | 1 | | 3 | 2 | 1 | 0 |
| | 3 | 1 | 0 | 3 | 2 | | 0 | 1 | 2 | 3 | | 3 | 2 | 1 | 0 | | 2 | 3 | 0 | 1 |
| c = 3, | | | b | | | c = 3, | | | b | | c = 3, | | | b | | c = 3, | | | b | |
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 3 | 2 | 1 | 0 | | 2 | 3 | 0 | 1 | | 1 | 0 | 3 | 2 | | 0 | 1 | 2 | 3 |
| | 1 | 2 | 3 | 0 | 1 | | 3 | 2 | 1 | 0 | | 0 | 1 | 2 | 3 | | 1 | 0 | 3 | 2 |
| | 2 | 1 | 0 | 3 | 2 | | 0 | 1 | 2 | 3 | | 3 | 2 | 1 | 0 | | 2 | 3 | 0 | 1 |
| | 3 | 0 | 1 | 2 | 3 | | 1 | 0 | 3 | 2 | | 2 | 3 | 0 | 1 | | 3 | 2 | 1 | 0 |

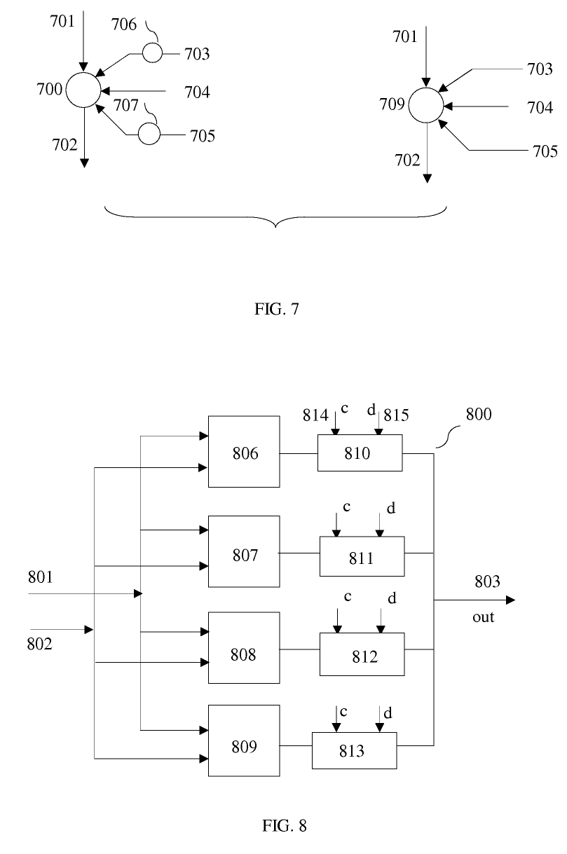

It is easy to see that the complete table can be created from 4 different tables. Furthermore, it is easy to see that each of the different tables can be created by applying 4 different 4-valued inverters, including identity, being: [0 1 2 3], [1 0 3 2], [2 3 0 1] and [3 2 1 0]. A diagram of an implementation is shown in FIG. 8. The diagram shows circuits 806, implementing for instance the table for c=0, d=0; circuit 807 implementing for instance the table for c=0, d=1; circuit 808, implementing for instance the table for c=0, d=2; and circuit 809, implementing for instance the table for c=0, d=3. Each of the circuits is entered with the 4-state signals a, and b which are received on inputs 801 and 802. The output 803 provides the signal in accordance with the state required by the truth table. The output state depends also on input signals c and d which are received on inputs 814 and 815 of a gating device 810, which determines if an output signal provided on an output of 806 is also provided on output 803. Circuits 807, 808 and 809 have similar gating devices 811, 812 and 813 respectively which are also inputted with signals representing states c and d. The passing conditions for each gating device are different and are determined by the truth table.

All signals can be received concurrently on the inputs and thus a signal on 803 can be provided very rapidly in response to input signals. It is recognized that multi-input circuits currently do exist. These are provided as binary circuits wherein signals are processed in multiple stages, thus creating latency in the switching time. Known Karnaugh diagram methods can assist in designing these multi-step circuits. It is believed that n-valued (with n>2) multi-input switching circuits as provided herein are novel.

In accordance with another aspect of the present invention one can change the truth table of sc4 in accordance with inverters inv1, inv2, inv3 and inv4 into a truth table of function sc4c. To keep the transformation relatively simple the circuit of FIG. 7 is used in 4-state mode, for performing the implementation of out=(u sc4 inv1(v) sc4 w sc4 inv2(x)). Herein, as an illustrative example, sc4 is the earlier provided function sc4.

In general one applies a multiplier as a transforming n-state element. The inventor has shown in earlier cited patent applications that such a limitation is not required. In a further illustrative example the inverters inv1=[3 0 2 1] and inv2=[2 1 3 0] will be applied. The truth table of the function using no inverters and reduced in accordance with the inverters is provided below.

| c = 0, | | | b | | | c = 0, | | | b | | c = 0, | | | b | | c = 0, | | | b | |
|---|---|---|---|---|---|---|---|---|---|---|---|---|---|---|---|---|---|---|---|---|
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 1 | 2 | 0 | 3 | | 2 | 1 | 3 | 0 | | 0 | 3 | 1 | 2 | | 3 | 0 | 2 | 1 |
| | 1 | 0 | 3 | 1 | 2 | | 3 | 0 | 2 | 1 | | 1 | 2 | 0 | 3 | | 2 | 1 | 3 | 0 |
| | 2 | 1 | 0 | 2 | 1 | | 0 | 3 | 1 | 2 | | 2 | 1 | 3 | 0 | | 1 | 2 | 0 | 3 |
| | 3 | 2 | 1 | 3 | 0 | | 1 | 2 | 0 | 3 | | 3 | 0 | 2 | 1 | | 0 | 3 | 1 | 2 |
| c = 1, | | | b | | | c = 1, | | | b | | c = 1, | | | b | | c = 1, | | | b | |
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 0 | 3 | 1 | 2 | | 3 | 0 | 2 | 1 | | 1 | 2 | 0 | 3 | | 2 | 1 | 3 | 0 |
| | 1 | 1 | 2 | 0 | 3 | | 2 | 1 | 3 | 0 | | 0 | 3 | 1 | 2 | | 3 | 0 | 2 | 1 |
| | 2 | 2 | 1 | 3 | 0 | | 1 | 2 | 0 | 3 | | 3 | 0 | 2 | 1 | | 0 | 3 | 1 | 2 |
| | 3 | 3 | 0 | 2 | 1 | | 0 | 3 | 1 | 2 | | 2 | 1 | 3 | 0 | | 1 | 2 | 0 | 3 |
| c = 2, | | | b | | | c = 2, | | | b | | c = 2, | | | b | | c = 2, | | | b | |
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 3 | 0 | 2 | 1 | | 0 | 3 | 1 | 2 | | 2 | 1 | 3 | 0 | | 1 | 2 | 0 | 3 |
| | 1 | 2 | 1 | 3 | 0 | | 1 | 2 | 0 | 3 | | 3 | 0 | 2 | 1 | | 0 | 3 | 1 | 2 |
| | 2 | 3 | 2 | 0 | 3 | | 2 | 1 | 3 | 0 | | 0 | 3 | 1 | 2 | | 3 | 0 | 2 | 1 |
| | 3 | 0 | 3 | 1 | 2 | | 3 | 0 | 2 | 1 | | 1 | 2 | 0 | 3 | | 2 | 1 | 3 | 0 |
| c = 2, | | | b | | | c = 2, | | | b | | c = 2, | | | b | | c = 2, | | | b | |
| d = 0 | | 0 | 1 | 2 | 3 | d = 1 | 0 | 1 | 2 | 3 | d = 2 | 0 | 1 | 2 | 3 | d = 3 | 0 | 1 | 2 | 3 |
| a | 0 | 2 | 1 | 3 | 0 | | 1 | 2 | 0 | 3 | | 3 | 0 | 2 | 1 | | 0 | 3 | 1 | 2 |
| | 1 | 3 | 0 | 2 | 1 | | 0 | 3 | 1 | 2 | | 2 | 1 | 3 | 0 | | 1 | 2 | 0 | 3 |
| | 2 | 0 | 3 | 1 | 2 | | 3 | 0 | 2 | 1 | | 1 | 2 | 0 | 3 | | 2 | 1 | 3 | 0 |
| | 3 | 1 | 2 | 0 | 3 | | 2 | 1 | 3 | 0 | | 0 | 3 | 1 | 2 | | 3 | 0 | 2 | 1 |

One can easily see that the truth table again has 4 unique individual tables as a function of a and b, occurring in different states of c and d. Accordingly, this truth table can be implemented as shown in FIG. 8. One may also implement the truth table in a similar way by using the inverters [0 3 1 2], [1 2 0 3], [2 1 3 0] and [3 0 2 1], being the rows in a truth table, or by using inverters [0 1 2 3], [1 0 3 2], [2 3 0 1], and [3 2 1 0] being the columns in a truth table. Using column inverters may have an advantage in this example as it includes the identity inverter.

Accordingly, as an aspect of the present invention one can implement an n-valued scrambler or descrambler in Fibonacci configuration with inverters in taps having identical functions with inverters at their inputs. Examples are provided wherein functions and inverters are reversible. This limitation is not required, and non-reversible functions and inverters may also be reduced in the manner described herein.

The previous example was using 4-state logic and inverters not being multipliers. The same applies to any n-state function. In a further example one may use a function structure such as provided in FIG. 7 for 3-state logic function modulo-3 addition with inv1=[2 0 1] and inv2=[0 2 1].

The truth table of the function reduced over the inverters is shown in the following table.

| | | | b | | | | b | | | | b | |
|---|---|---|---|---|---|---|---|---|---|---|---|---|
| c = 0, d = 0 | | 0 | 1 | 2 | c = 0, d = 1 | 0 | 1 | 2 | c = 0, d = 2 | 0 | 1 | 2 |
| a | 0 | 2 | 0 | 1 | | 1 | 2 | 0 | | 0 | 1 | 2 |
| | 1 | 0 | 1 | 2 | | 2 | 0 | 1 | | 1 | 2 | 0 |
| | 2 | 1 | 2 | 0 | | 0 | 1 | 2 | | 2 | 0 | 1 |
| | | | b | | | | b | | | | b | |
| c = 1, d = 0 | | 0 | 1 | 2 | c = 1, d = 1 | 0 | 1 | 2 | c = 1, d = 2 | 0 | 1 | 2 |
| a | 0 | 0 | 1 | 2 | | 2 | 0 | 1 | | 1 | 2 | 0 |
| | 1 | 1 | 2 | 0 | | 0 | 1 | 2 | | 2 | 0 | 1 |
| | 2 | 2 | 0 | 1 | | 1 | 2 | 0 | | 0 | 1 | 2 |
| | | | b | | | | b | | | | b | |
| c = 2, d = 0 | | 0 | 1 | 2 | c = 2, d = 1 | 0 | 1 | 2 | c = 2, d = 2 | 0 | 1 | 2 |
| a | 0 | 1 | 2 | 0 | | 0 | 1 | 2 | | 2 | 0 | 1 |
| | 1 | 2 | 0 | 1 | | 1 | 2 | 0 | | 0 | 1 | 2 |
| | 2 | 0 | 1 | 2 | | 2 | 0 | 1 | | 1 | 2 | 0 |

One can see that this function can be implementing by using implementations of just 3 tables for a and b. One may also implement the truth table by using three 3-state inverters: [0 1 2], [1 2 0] and [2 0 1] of which one is identity.

One may apply the reduction methods for general n-state inverters. One may also apply the method when the function is an addition and the inverters are multipliers. In such a case one may want to generate residue and carry signals. It should be clear that the basic residue generating function (which is in general a modulo-n addition) and the carry generating function are different. One may apply the methods disclosed herein to generate residue and carry truth tables that are modified in accordance with inverters at the input of the unmodified function.

### The Binary Case

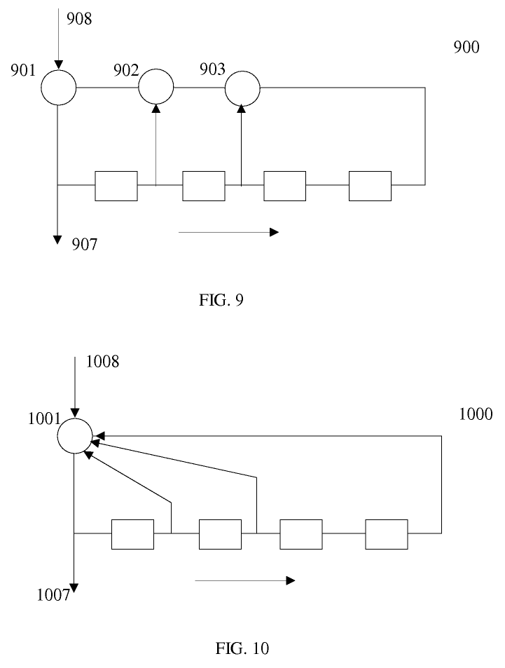

The above methods are illustrated by providing n-valued examples with n>2. One may apply the methods and apparatus provided as an aspect of the present invention also in binary switching. For instance one may create a binary device with p inputs that has limited switching delay. As an example a binary Fibonacci LFSR based scrambler 900 is provided in FIG. 9. It has the binary 2-input XOR functions 901, 902 and 903. A to be scrambled binary signal is received on input 908. A scrambled binary signal is provided on output 908. Like with LFSRs a clock signal may be required and is assumed but not drawn in the figures. A problem with the scrambler may be the delay created by the individual functions. Function 902 has to wait for function 903 and function 901 has to wait for function 902 to have completed generating a result.

One may replace the circuit of FIG. 9 with the reduced circuit 1000 of FIG. 10. Herein 4-input function 1001 replaces 901, 902 and 903. The input 1008 is equivalent with 908 and output 1007 is equivalent with 907. The truth table of 1001 is provided in the following tables.

| | | | b | | | b |
|---|---|---|---|---|---|---|
| c = 0, d = 0 | | 0 | 1 | c = 0, d = 1 | 0 | 1 |
| a | 0 | 0 | 1 | | 1 | 0 |
| | 1 | 1 | 0 | | 0 | 1 |
| | | | b | | | b |
| c = 1, d = 0 | | 0 | 1 | c = 1, d = 1 | 0 | 1 |
| a | 0 | 1 | 0 | | 0 | 1 |
| | 1 | 0 | 1 | | 1 | 0 |

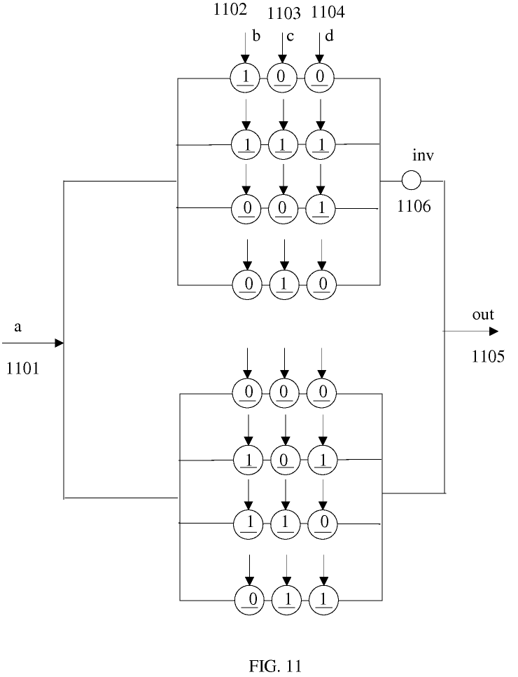

One may implement the truth table with multiple binary switches, of which one implementation is shown in FIG. 11. It was disclosed by the inventor in U.S. Pat. No. 7,218,144 issued on May 15, 2007, which is incorporated herein by reference in its entirety, how one may realize in close to one switching cycle a composite truth table. One can easily distinguish from the above truth table how for instance a signal representing a state ‘a’ on input 1101 sees an inverter ‘inv’ 1106 when signal representing b=1 on input 1102, a signal representing c=0 on input 1103 and a signal representing d=0 on input 1104, will generate a signal ‘out’ on the output 1105. In this diagram switches in equivalent column positions will all receive the same control signal: all switches in the first column will receive a signal representing ‘b’, etc. Because all signals are provided at the same time there is limited latency.

The representation as provided in for instance FIG. 11 may create confusion around an electronic implementation. The actual electronic circuits, as are described in earlier cited U.S. Pat. No. 7,218,144, when they have state 0 will have measures that make sure that a state 0 represented by absence of signal, will not be an indefinite signal created by a floating gate with an unknown potential. If one wants to have one physical visualization of the switching networks of for instance FIGS. 4b and 11 one may picture the switches for instance as optical switches wherein information carrying signals are represented by light, either by an intensity or a wavelength of light, and wherein an optical control signal may cause states at an output to be related to a state at the input. Such a switch is disclosed by the inventor in for instance U.S. Patent Application Publication No. 20080111583, published on May 15, 2008 which is incorporated herein by reference in its entirety.

One may implement the truth tables with a look-up table, wherein input signals form an address in a table, and wherein the content of the memory at that address is the required output state. This memory approach applies to any n-state multi-input problem with n≧2 and for n>2. Binary memories are known. N-state memories with n>2 are also known and are disclosed by the inventor for instance in U.S. Pat. No. 7,397,690 filed on May 27, 2005, which is incorporated herein by reference in its entirety.

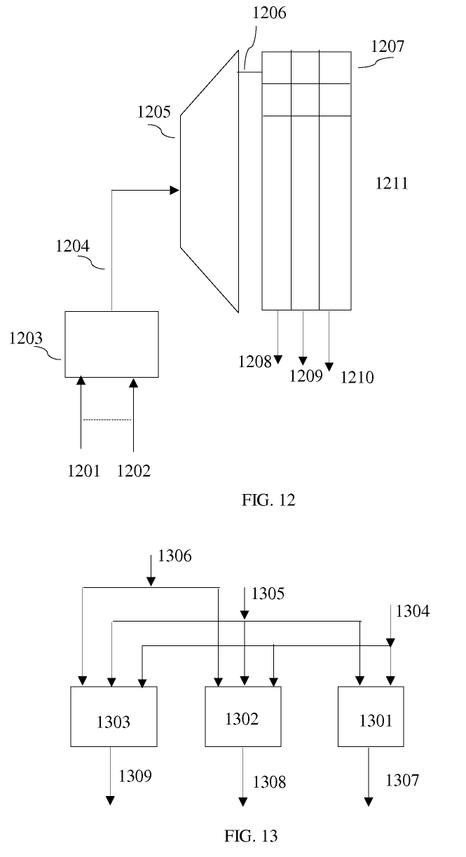

In accordance with a further aspect of the present invention, a memory based look-up table n-state multi-input device with n≧2 is provided. A diagram of an possible embodiment is shown in FIG. 12. The look-up table is stored in an addressable n-state memory 1211. The memory may have words or lines of n-state symbols stored in the memory 1211. Each word, which may contain a plurality of symbols or a single symbol, is associated with a memory address. A symbol or a word of symbols at an address may be activated or made available at an output when the address is activated and enables an address line, for instance address line 1206. An address line 1206 may be selected by an address line activation generator which may be an address decoder 1205 to activate memory line 1207 of which the content will be provided on outputs 1208, 1209 and 1210 in the illustrative example of FIG. 12. Address decoders are well known in the art.

In one embodiment input signals may be provided directly on 1205 and translated into an enabled memory line. In a further embodiment, one may input p-input signals on inputs of which inputs 1201 to 1202 are shown, on a signal translator 1203, which may generate on 1204 a serial signal that is provided to the decoder 1205. The signal 1205 may also represent a plurality of parallel signals that is provided to 1205. This embodiment allows for instance n-state signals to be translated into binary signals. In one embodiment the signals provided to 1205 are binary signals. In a further embodiment signals provided to 1205 are non-binary signals.

In the context of the above the outputs 1208, 1209 and 1210 may provide each an n-state signal representing an n-state symbol. They may also provide k-state symbol words with k<n of a plurality of k-state symbols, each word representing an n-state symbol.

The implementation of m-state scramblers and descramblers in m-state addressable memory is disclosed by the inventor in U.S. patent application Ser. No. 11/555,730 filed on Nov. 2, 2006 which is incorporated herein by reference in its entirety. Herein m can be 2. M can also be m>2; and m>3.

For instance FIG. 12 may represent part of a multiplier of a multiplicand that contains radix-n digits a1, a2, a3, a4 and a radix multiplier containing radix-n digits b1, b2, b3 and b4. It is known in computer arithmetic that a circuit or a hardware implementation of the multiplication of a4a3a2a1 and b4b3b2b1 has to resolve in some way the partial product sum (a4*b1+a3*b2+a2*b3+a1*b4). One can check this by writing out the individual steps of the multiplication. Assume in an illustrative example that all digits are radix-4.

In a first embodiment one may use a look-up table memory enabled to store and retrieve 4-valued signals. The addresses of the memory lines are determined by 2*4 4-valued input signals. The radix-4 partial product sum (a4*b1+a3*b2+a2*b3+a1*b4) can be at most: (3*3+3*3+3*3+3*3)=36. In radix-4 notation 36=2*4²+1*4¹+0*4⁰=[2 1 0]-radix-4. The maximum number that can be expressed by 3 radix-4 digits is: [3 3 3]=3*4²+3*4¹+3*4⁰=48+12+3=63. This indicates that 3 radix-4 digits can represent the sum of a maximum of 7 partial products. Accordingly, one may use a 14 input 4-valued memory table with 3-outputs, each output enabled to provide a signal that represents a 4-valued digit. The three signals provided on three outputs of the memory representing a sum of at maximum 7 partial products of a multiplication of a multiplicand having at least digits a1, a2, a3, a4, a5, a6, a7 and a multiplier having at least digits b1, b2, b3, b4, b5, b6, b7.

In the illustrative example using 8 inputs representing radix-4 numbers the truth table stored in the memory is determined by a 2*4 input radix-4 addition residue, a 2*4 input radix-4 addition first carry, and a 2*4 input radix-4 addition second carry, applying the methods that are provided herein above. As was shown above, one may also implement the 4-valued truth tables by applying switches and inverters. A major benefit in evaluating combined sums of partial products is that one can save significant amounts of clock cycles that may be required in a ripple in a carry, originating from multiple consecutive additions.

The above method also applies when the multiplier is a constant, rather than a variable. For instance multiplications in Digital Signal Processing (DSP) applications such as digital filters may be with constant factors. Constant factors will simplify or diminish the size of a required truth table. The multiplication method and implementation in hardware that can perform the processing of the signals may make DSP applications much faster and may allow real-time processing in DSP much easier with potentially lower power demand and less circuitry at lower clock cycles.

An radix-n multiplication of a multiplicand of at least p radix-n digits and a multiplier of at least p radix-n digits with n>2 and p>2 may thus be performed by methods as provided above in circumventing determining time consuming intermediate results and directly determining a residue or a carry of a sum of at least 3 partial products having the same radix-n position. When the multiplier is a variable one may use signals representing the digits of the multiplier to select the implementation of the correct truth table, wherein that implementation has as inputs the digits of the multiplicand. When the multiplier is a constant then there is only one truth table that has to be implemented for determining a residue of a sum of p partial products and that has the signals representing the digits of the multiplicand as input. The same applies for determining a carry of such a sum.

As was shown in patent application Ser. No. 11/018,956, one may further reduce or postpone the generating of carry ripples by applying radix-n Carry Save Add (CSA) and radix-n Carry Predict and related methods.

One may process radix-n numbers in accordance with an aspect of the present invention by representing a radix-n digit by an n-valued signal and applying n-valued circuitry including n-valued memory, to generate n-valued signals representing again radix-n digits. In a further embodiment one may also represent a radix-n digit by a plurality of radix-k symbols and representing a radix-k digit by a k-valued signal and processing k-valued signals by k-valued circuitry including k-valued memory. In that case it may be that k=2. In that case an input in FIG. 12 may receive a word of k-valued or binary signals. The memory 1211 may be a binary memory. The address decoder 1205 may be binary and the outputs 1208, 1209 and 1210 may provide binary words, representing an n-valued symbol. For instance if FIG. 12 is used to generate a 3 digit radix-4 partial product sum, each input may receive a 2-bit word and each output may provide a 2-bit word. Variations of k-valued representation of radix-n symbols and k-valued processing thereof are fully contemplated and are aspects of the present invention

The resulting function 702 can be expressed by out=u sc5 v sc5 w sc5 x sc5 which is equivalent to 701. One has thus reduced an implementation wherein first symbols at inputs have to be inverted and then inputted to an implementation of sc to a single implementation wherein symbols u, v, w and x can directly be inputted to an implementation of a function.

It was shown in an earlier cited patent application by the inventor how such implementations can be realized with gates and inverters. An alternative may be wherein a truth table is implemented in a memory chip wherein for instance inputs form an address. In accordance with one aspect of the present invention instead of implementing the inverters and the function in separate tables in one or more memory chips one can reduce the implementation to a single table on a chip.

One may also implement the truth tables in software on a processor. By applying the reduced truth tables one can limit the number of instruction that have to be executed, thus accelerating the performance of methods that use multi-input functions.

The above methods and apparatus apply to multi-input problems which can be implemented in a circuit as shown in for instance FIG. 11. One may say that all variables are of the same rank. For instance in a multiplication in accordance with an aspect of the present invention products a1b1, a2b2 and a3b3 all represent a coefficient of a term being a power of n. In formula: sum of partial products Sum=(a1b1*n^{p}+a2b2*n^{p}+a3b3*n^{p})=(a1b1+a2b2+a3b3)*n^{p}. Another way to address a multiplication is to try to resolve: Sum2=(a1*n^{p}+²+a2*n^{p+1}a3*n^{p})*b1. This problem is fundamentally different from the earlier method as the coefficients a1b1, a2b1 and a3b1 all have a different rank as they are associated with different exponents of base n. The issue of generated carry makes implementing a solution a bit more complicated. The problem is simpler because the multiplier is identical for each partial product. The problem may also appear a bit more complex because the carry depends on an earlier value of a digit of a multiplicand.

An additional problem is the ripple of the carry. One has to develop the truth tables for the residues and end carry based on multiplier as well as multiplicand. One is referred to U.S. Pat. No. 4,566,075 to Guttag, which describes the problem, but only solves it for generating a residue and a carry for a single partial product. The addition of multiple partial products are solved in the classical way and do not provide any saving in clock cycles. For instance, FIG. 7 of Guttag, shows a diagram to solve adding three partial products, which requires in Guttag at least 4 different steps.

In accordance with an aspect of the present invention, a method is provided to generate a sum of at least two partial products, each partial product being generated by a digit of the multiplicand “aₙ” with a digit of the multiplier “b₀”. In formula one can express the problem as solving Sum=b₀*[a₁ a₂], herein a₁ represents the coefficient related to a term n^{p+1}, and a₂ represents the coefficient of a term n^{p}.

The following tables show the truth tables for generating residues and carry for the ternary case or for the 3-valued implementation of the radix-3 multiplication of b₀*[a₁ a₂] wherein a1 and a2 are two neighboring digits in the multiplicand and b0 is a digit in the multiplier in a radix-3 multiplication. The following table shows the truth table for generating the first residue. This residue depends only on the value of a0 and b0:

| | | a0 | | |
|---|---|---|---|---|
| Residue 1 | | 0 | 1 | 2 |
| b0 | 0 | 0 | 0 | 0 |
| | 1 | 0 | 1 | 2 |
| | 2 | 0 | 2 | 1 |

The following table shows the truth table for generating the second residue. This table depends on, of course, b0 and a1. However, it depends also on a0. For instance, when a0=2 and b0=2, the residue is 1, but also a carry is generated by b0*a0. This carry should be added to any residue of b0a1.

| | | a1 | | | | | a1 | | | | | a1 | | |
|---|---|---|---|---|---|---|---|---|---|---|---|---|---|---|
| a0 = 0 | | 0 | 1 | 2 | a0 = 1 | | 0 | 1 | 2 | a0 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 1 | 2 | | 1 | 0 | 1 | 2 | | 1 | 0 | 1 | 2 |
| | 2 | 0 | 2 | 1 | | 2 | 0 | 2 | 1 | | 2 | 1 | 0 | 2 |

The following table shows the truth table for generating the carry, which should be available for further processing. The carry depends on b0, a0 and a1. One can see that a rippling of the carry takes place for a0=2; a1=1; and b0=2.

| | | a1 | | | | | a1 | | | | | a1 | | |
|---|---|---|---|---|---|---|---|---|---|---|---|---|---|---|
| a0 = 0 | | 0 | 1 | 2 | a0 = 1 | | 0 | 1 | 2 | a0 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 0 | 0 | | 1 | 0 | 0 | 0 | | 1 | 0 | 0 | 0 |
| | 2 | 0 | 0 | 1 | | 2 | 0 | 0 | 1 | | 2 | 0 | 1 | 1 |

A diagram of an implementation of this combining of generating the sum partial products of neighboring digits is shown in FIG. 13. Input 1304 receives a signal representing b0; input 1305 receives a signal representing a0; and input 1306 receives a signal representing a1. Box 1301 implements the truth table of the first residue, a signal representing that residue is provided on output 1307. Box 1302 implements the truth table of the second residue, a signal representing that residue is provided on output 1308. Box 1303 implements the truth table of the carry, a signal representing that carry is provided on output 1309. The implementation of the truth table may be in a memory form as was shown in FIG. 12. It may also be in a circuit form as was shown in FIG. 11.

In a conventional multiplication apparatus with a rippling carry the steps may be: (1) calculate residues and carries of b0*a1 and b0*a0; (2) determine if second residue and carry from first partial product generate a new carry. Accordingly, one may have reduced the total calculation from two steps to one step in the radix-3 case, by applying the novel method.

A similar approach can be applied for any radix-n. The truth tables for radix-4 in accordance with an implementation as shown in FIG. 13 are provided below.

The following table provides the truth table for generating the first residue. The first residue depends on b0 and a0.

| | | | a0 | | |
|---|---|---|---|---|---|
| | | 0 | 1 | 2 | 3 |
| b0 | 0 | 0 | 0 | 0 | 0 |
| | 1 | 0 | 1 | 2 | 3 |
| | 2 | 2 | 0 | 2 | 0 |
| | 3 | 0 | 3 | 2 | 1 |

The following table shows the truth table for generating the second residue. This table depends on, of course, b0 and a1. However, it depends also on a0. For instance, when a0=2 and b0=2, the residue is 1, but also a carry is generated by b0*a0. This carry should be added to any residue of b0*a1.

| | | | a1 | | | | | | a1 | | | | | | a1 | | | | | | a1 | | |
|---|---|---|---|---|---|---|---|---|---|---|---|---|---|---|---|---|---|---|---|---|---|---|---|
| a0 = 0 | | 0 | 1 | 2 | 3 | a0 = 1 | | 0 | 1 | 2 | 3 | a0 = 2 | | 0 | 1 | 2 | 3 | a0 = 3 | | 0 | 1 | 2 | 3 |
| b0 | 0 | 0 | 0 | 0 | 0 | b0 | 0 | 0 | 0 | 0 | 0 | b0 | 0 | 0 | 0 | 0 | 0 | b0 | 0 | 0 | 0 | 0 | 0 |
| | 1 | 0 | 1 | 2 | 3 | | 1 | 0 | 1 | 2 | 3 | | 1 | 0 | 1 | 2 | 3 | | 1 | 0 | 1 | 2 | 3 |
| | 2 | 0 | 2 | 0 | 2 | | 2 | 0 | 2 | 0 | 2 | | 2 | 1 | 3 | 1 | 3 | | 2 | 1 | 3 | 1 | 3 |
| | 3 | 0 | 3 | 2 | 1 | | 3 | 0 | 3 | 2 | 1 | | 3 | 1 | 0 | 3 | 2 | | 3 | 2 | 1 | 0 | 3 |

The following table shows the truth table for generating the carry, which should be available for further processing. The carry depends on b0, a0 and a1. One can see that a rippling of the carry takes place for a0=2; a1=1; and b0=3.

| | | | a1 | | | | | | a1 | | | | | | a1 | | | | | | a1 | | |
|---|---|---|---|---|---|---|---|---|---|---|---|---|---|---|---|---|---|---|---|---|---|---|---|
| a0 = 0 | | 0 | 1 | 2 | 3 | a0 = 1 | | 0 | 1 | 2 | 3 | a0 = 2 | | 0 | 1 | 2 | 3 | a0 = 3 | | 0 | 1 | 2 | 3 |
| b0 | 0 | 0 | 0 | 0 | 0 | b0 | 0 | 0 | 0 | 0 | 0 | b0 | 0 | 0 | 0 | 0 | 0 | b0 | 0 | 0 | 0 | 0 | 0 |
| | 1 | 0 | 0 | 0 | 0 | | 1 | 0 | 0 | 0 | 0 | | 1 | 0 | 0 | 0 | 0 | | 1 | 0 | 0 | 0 | 0 |
| | 2 | 0 | 0 | 1 | 1 | | 2 | 0 | 0 | 1 | 1 | | 2 | 0 | 0 | 1 | 1 | | 2 | 0 | 0 | 1 | 1 |
| | 3 | 0 | 0 | 1 | 2 | | 3 | 0 | 0 | 1 | 2 | | 3 | 0 | 1 | 1 | 2 | | 3 | 0 | 1 | 1 | 2 |

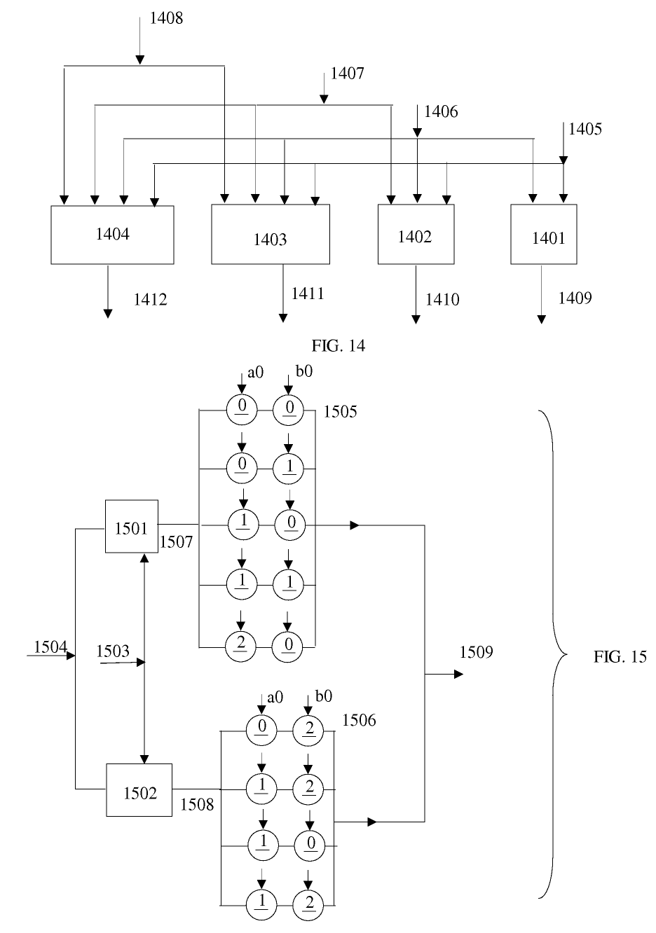

The approach as provided in FIG. 13 will generate even more time savings if one expands the number of inputs. The following shows a radix-3 example for a single step implementation of b0*[a2 a1 a0]. The digit a2 is the next highest digit in the radix-3 (or radix-n if generalized) number [a2 a1 a0]. The digit is added to the left side because the carry ripples from right to left. This is illustrated in FIG. 14. The system contains a two-input function 1401 with output 1409, a three-input function 1402 with output 1410, a four-input function 1403 with output 1410; and a four-input function 1404 with output 1411. Input 1405 receives a signal representing multiplier digit b0; input 1406 receives a signal representing multiplicand digit a0; input 1407 receives a signal representing multiplicand digit a1; and input 1408 receives a signal representing multiplicand digit a2.

Output 1409 provides a first residue, output 1410 provides a second residue; output 1411 provides a third residue; and output 1412 provides the carry of the multiplication b0*[a2 a1 a0].

The truth table for the carry is provided in the following table.

| a0 = 0 | | a2 | | | a0 = 0 | | a2 | | | a0 = 0 | | a2 | | |
|---|---|---|---|---|---|---|---|---|---|---|---|---|---|---|
| a1 = 0 | | 0 | 1 | 2 | a1 = 1 | | 0 | 1 | 2 | a1 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 0 | 0 | | 1 | 0 | 0 | 0 | | 1 | 0 | 0 | 0 |
| | 2 | 0 | 0 | 1 | | 2 | 0 | 0 | 1 | | 2 | 0 | 1 | 1 |
| a0 = 1 | | a2 | | | a0 = 1 | | a2 | | | a0 = 1 | | a2 | | |
| a1 = 0 | | 0 | 1 | 2 | a1 = 1 | | 0 | 1 | 2 | a1 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 0 | 0 | | 1 | 0 | 0 | 0 | | 1 | 0 | 0 | 0 |
| | 2 | 0 | 0 | 1 | | 2 | 0 | 0 | 1 | | 2 | 0 | 1 | 1 |
| a0 = 2 | | a2 | | | a0 = 2 | | a2 | | | a0 = 2 | | a2 | | |
| a1 = 0 | | 0 | 1 | 2 | a1 = 1 | | 0 | 1 | 2 | a1 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 0 | 0 | | 1 | 0 | 0 | 0 | | 1 | 0 | 0 | 0 |
| | 2 | 0 | 0 | 1 | | 2 | 0 | 1 | 1 | | 2 | 0 | 1 | 1 |

It can be seen that basically two truth tables are implemented and repeated. Accordingly, one may apply an implementation that is in structure similar to FIG. 8. A diagram of such an implementation is shown in FIG. 15. Herein 1501 may be an implementation of the 3 by 3 truth table of b0 and a2 as inputs with the carry as output for a0=1 and a1=0 for instance. Input 1503 receives a signal representing a2 and input 1504 receives a signal representing b0. The implementation of the truth table provides a signal on output 1507 to output 1509 when the network of switches 1505 is enabled to pass on the state of output 1507 to 1509. One will recognize the symbols for the n-state switches, wherein the control inputs receive signals representing a1 and a0 respectively. One can easily map the pass conditions of 1505 with the truth table as provided above.

Box 1502 may be an implementation of the 3 by 3 truth table of b0 and a2 as inputs with the carry as output for a0=2 and a1=2. Input 1503 of 1502 is the same input as of 1501 receives a signal representing a2 and input 1504 receives a signal representing b0. The implementation of the truth table provides a signal on output 1508 to output 1509 when the network of switches 1506 is enabled to pass on the state of output 1508 to 1509. One will recognize the symbols for the n-state switches, wherein the control inputs receive signals representing a1 and a0 respectively. One can easily map the pass conditions of 1506 with the truth table as provided above.

The output 1509 will thus provide the same output as output 1412 in FIG. 14.

The third residue provided on output 1411 of the radix multiplication depends on b0, a2, a1 and a0. Its truth table is provided in the following tables.

| a0 = 0 | | a2 | | | a0 = 0 | | a2 | | | a0 = 0 | | a2 | | |
|---|---|---|---|---|---|---|---|---|---|---|---|---|---|---|
| a1 = 0 | | 0 | 1 | 2 | a1 = 1 | | 0 | 1 | 2 | a1 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 1 | 2 | | 1 | 0 | 1 | 2 | | 1 | 0 | 1 | 2 |
| | 2 | 0 | 2 | 1 | | 2 | 0 | 2 | 1 | | 2 | 1 | 0 | 2 |
| a0 = 1 | | a2 | | | a0 = 1 | | a2 | | | a0 = 1 | | a2 | | |
| a1 = 0 | | 0 | 1 | 2 | a1 = 1 | | 0 | 1 | 2 | a1 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 1 | 2 | | 1 | 0 | 1 | 2 | | 1 | 0 | 1 | 2 |
| | 2 | 0 | 2 | 1 | | 2 | 0 | 2 | 1 | | 2 | 1 | 0 | 2 |
| a0 = 2 | | a2 | | | a0 = 2 | | a2 | | | a0 = 2 | | a2 | | |
| a1 = 0 | | 0 | 1 | 2 | a1 = 1 | | 0 | 1 | 2 | a1 = 2 | | 0 | 1 | 2 |
| b0 | 0 | 0 | 0 | 0 | b0 | 0 | 0 | 0 | 0 | b0 | 0 | 0 | 0 | 0 |
| | 1 | 0 | 1 | 2 | | 1 | 0 | 1 | 2 | | 1 | 0 | 1 | 2 |
| | 2 | 0 | 2 | 1 | | 2 | 1 | 0 | 2 | | 2 | 1 | 0 | 2 |

It can be seen that a limited number of basic truth tables are used. Accordingly, one may apply an implementation similar to what is shown in FIG. 15.

The second residue as provided on output 1410 depends on b0, a1, and a0. One can easily determine the truth table. The truth table for generating the first residue on 1409 depends on b0 and a0.

The above approach may also be used for determining any radix-n multiplication. For instance in case of a radix-4 multiplication of b0*[a2 a1 a0] one also has to generate a carry, a third residue, a second residue and a first residue. Showing all truth tables would be repetitive. The following table shows the 4 tables that may be used to create the truth table for creating the third residue.

| | | | a2 | | | | | | a2 | | | | | | a2 | | | | | | a2 | | |
|---|---|---|---|---|---|---|---|---|---|---|---|---|---|---|---|---|---|---|---|---|---|---|---|
| | | 0 | 1 | 2 | 3 | | | 0 | 1 | 2 | 3 | | | 0 | 1 | 2 | 3 | | | 0 | 1 | 2 | 3 |
| b0 | 0 | 0 | 0 | 0 | 0 | b0 | 0 | 0 | 0 | 0 | 0 | b0 | 0 | 0 | 0 | 0 | 0 | b0 | 0 | 0 | 0 | 0 | 0 |
| | 1 | 0 | 1 | 2 | 3 | | 1 | 0 | 1 | 2 | 3 | | 1 | 0 | 1 | 2 | 3 | | 1 | 0 | 1 | 2 | 3 |
| | 2 | 0 | 2 | 0 | 2 | | 2 | 0 | 2 | 0 | 2 | | 2 | 1 | 3 | 1 | 3 | | 2 | 1 | 3 | 1 | 3 |
| | 3 | 0 | 3 | 2 | 1 | | 3 | 1 | 0 | 3 | 2 | | 3 | 1 | 0 | 3 | 2 | | 3 | 2 | 1 | 0 | 3 |

Each individual table occurs for different values of a1 and a0. However, despite these conditions only 4 different tables can be applied and the approach of FIG. 15 can be used to implement the 4-valued or radix-4 case. The difference between the radix-3 case and the radix-4 case is the number of individual tables that have to be applied.

One may apply similar approaches to longer multiplications with more digits. One may also apply the approach to a higher radix multiplication.

A digital filter can be described by

$$y ( n ) = {\sum }_{i = 0}^{k} ai \cdot x ( n - i ) + {\sum }_{i = 1}^{k} bi \cdot y ( n - i ) .$$

Herein ai and bi are filter constants. The term y(n) represents a signal sample generated by the filter. If bi≠0, the filter is a recursive filter. When bi=0 the filter is a non-recursive filter as it only depends on previously provided input samples, and not on generated samples. In general filter constants are pre-determined and known. The input samples, output samples and filter constants can be radix-n numbers which can be represented by a signal. A term created by a product ai.x(n−i) and/or bi.y(n−i) may be created by a multiplicand which is a multi-digit (greater than 2 digits) radix-n number and a multiplier which is a multi-digit (greater than 2 digits) radix-n number. It should be clear that in such a case the multiplications may be performed using one of the methods provided herein as an aspect of the present invention, thus improving the speed of the multiplication because fewer partial products have to be evaluated.

The method as provided herein as an aspect of the present invention may be applied in any physical implementation of a multiplication of a m digit radix-n multiplicand and a k digit radix-n multiplier with m and k greater than 2 and n greater than 2 or n greater than 3. Such a multiplication for instance may be applied in a radix-n Fast Fourier Transform (FFT) or any other radix-n Digital Signal Processing operation, which may involve multiplications to determine a radix-n statistical entity.

Assume that a multiplication is of multiplicand a2a1a0 being of three radix-n variable digits a2, a1 and a0 with n>2 or n>3, with a multiplier b2b1b0 of three radix-n digits. Such a multiplication has to resolve at least the term (a2b0+a1b1+a0b2) to determine the product. It may be that a multiplier is a constant multiplier with multi radix-n digits. In that case one truth table of evaluating the residue of a sum of the at least 3 partial products is an 3 input (for a2 a1 and a0) radix-n addition modified in accordance with b2, b1 and b0. The truth table includes at least one three input truth table for a first carry, and may involve a second carry truth table or even third or more carries, depending on the number of inputs.

If the multiplier is also a variable, one may apply means to select the correct truth table from a set of possible truth tables. An n-valued switch may be such a means. An address generator for a memory may be another means to select the correct truth table.

It may be that in a column of calculation related to a power of n^{p} in a radix-n multiplication several residues of sum products of a multi-input multiplication are generated. A column may also contain one or more residues and/or one or more carries generated from results in previous columns. It is known that these additions may generate further carries that will ripple through the additions. As was described in previously cited U.S. patent application Ser. No. 11/679,316 and as is known in the art one may apply different methods in adders to limit ripple effects. One such a method relates to Carry Save Add, which postpones generating a carry to the last possible moment and Carry Look Ahead methods which predicts a carry without having to execute the full adder. These methods have also been described in U.S. patent application Ser. No. 11/679,316 from radix-n additions and are contemplated to be applied in the multi-input multiplication.

The inventor has disclosed in U.S. Pat. No. 7,218,144 issued on May 15, 2007 and filed on Nov. 30, 2004, which is incorporated herein by reference in its entirety, how one can create a binary or an n-valued switching circuit from binary and/or n-valued logic switches which generates a results from multiple input signals about within one clock cycle. Applying for instance this technology allows to execute the rather complex truth tables of a multi-input binary and/or n-valued logic function in or about in one clock cycle.

This aspect plays a role in the binary or n-valued Fibonacci LFSR based scrambler and descrambler as described herein. This allows to replace multiple 2-input logic functions that have to be executed in a serial way, to be replaced with a single multi-input logic function, that can be executed in or about in a single clock cycle. This aspect was illustrated in for instance FIGS. 6 and 7. FIG. 7 illustrates how multipliers at an input in the n-valued case for n>2 or n>3 can be reduced into the truth table of the multi-input logic function.

Herein methods for at least two multi-input radix-n multiplications are provided. A first method relates to evaluating a sum of at least 3 partial products, its residue as well as its carry or carries, wherein each partial product represents a coefficient of a power of n^{p}, wherein n>2 or n>3. For instance the radix-n multiplication a2a1a0*b2b1b0, may be written as: (a2a1a0*b2b1b0)=a2b2*n⁴+(a2b1+a1b2)*n³+(a2b0+a1b1+a0b2)*n²+(a1b0+a0b1)*n¹+a0b0*n⁰. The coefficients only indicate terms that have to be evaluated or must be part of an overall evaluation to generate the correct product. Stating that an evaluation has to take place is not the same as taking place. Circuitry, for instance as disclosed herein, is required to actually perform the evaluation.

A second and different method relates to evaluating b0*(a2a1a0) in radix-n with n>2 or n>3. This relates to evaluating for instance b0*a2*n²+b0*a1*n¹+b0*a0*n⁰. This method requires a different set of tables for the multi-input truth table, as was shown herein.

It was shown that the apparatus and methods provided as aspects of the present invention can process at least three input signals at the same time, to generate within the one clock cycle an output signal. A clock cycle for aspects of the current invention may be defined as the time it takes to read an output value from a memory when multiple input signals are provided on an address translator. Another definition may be, the maximum time a takes a signal to generate an output when all relevant switches in a datapath are enabled in parallel at the same time. This is demonstrated for instance in FIG. 11. All switches 1102, 1103 and 1104 are enabled at the same time. A first path may go through three switches to an output. A second signal may go through three switches and through an inverter, for instance 1106. The second path may be longer in time than the first one. Accordingly, one should base the clock cycle duration on the longer path. One may call this a clock cycle based on parallel switching. This is different from standard multi input circuits, wherein a first set of for instance two inputs generates an output, and processing has to wait at a certain stage on an intermediate result before it can continue with processing. In general the clock cycle may be determined by the time it takes to generate a first intermediate result.

The methods and apparatus as provided herein do not have an intermediate result. For instance residues and carries are generated directly without intermediate results. In conventional methods the residue of for instance (a1b1+a2b2+a3b3) requires generating intermediate partial products. In accordance with an aspect of the present invention, no intermediate result is required to be processed to achieve the desired result. One may argue that physically one may determine an intermediate result at any point in a circuit, for instance before or after an inverter is enabled. An intermediate result herein is intended to mean, a result that is provided on an output at a certain time and that is determined by a truth table, the intermediate result being required to determine an end result while the end result is not available at the same time or at substantially the same time as when the intermediate result is available.

The multi-input methods and apparatus provided herein as different aspects of the present invention are illustrated for instance with radix-n multiplications. A radix-n multiplication may be interpreted as being a modulo-n multiplication, thus generating a residue and in relevant cases at least one carry. One may also use methods and apparatus for reducing or avoiding evaluating intermediate steps in multi-input functions, with at least one function having an inverter at an input. Such a function may be an adder over GF(n) and an inverter at an input may be a multiplier over GF(n). However, such an inverter may also not be a multiplier providing a transformational state for input state 0. Functions and inverters may be reversible. They may also be non-reversible.

As an illustrative example the truth table of an n-state 4-input expression is provided. The expression is out=[{(a sc1 b) sc2 c} sc3 d]. For illustrative purposes the example is provided for n=4. It should be clear that the illustrated reduction may be applied to any n≧2, for n>2, for n>3, etc. Assume the following truth tables for 4-state functions sc1, sc2 and sc3.

| sc1 | | 0 | 1 | 2 | 3 | sc2 | 0 | 1 | 2 | 3 | sc3 | 0 | 1 | 2 | 3 |
|---|---|---|---|---|---|---|---|---|---|---|---|---|---|---|---|
| | 0 | 3 | 2 | 1 | 0 | | 0 | 1 | 2 | 3 | | 0 | 1 | 2 | 3 |
| | 1 | 2 | 1 | 0 | 3 | | 1 | 2 | 3 | 0 | | 1 | 0 | 3 | 2 |
| | 2 | 1 | 0 | 3 | 2 | | 2 | 3 | 0 | 1 | | 2 | 3 | 0 | 1 |
| | 3 | 0 | 3 | 2 | 1 | | 3 | 0 | 1 | 2 | | 3 | 2 | 1 | 0 |

The functions are reversible. One may create the truth table for the above expression, which is provided by the following tables.

| c = 1, | | | b | | | c = 2, | | | b | | c = 3, | | | b | | c = 3, | | | b | |
|---|---|---|---|---|---|---|---|---|---|---|---|---|---|---|---|---|---|---|---|---|
| d = 0 | | 0 | 1 | 2 | 3 | d = 0 | 0 | 1 | 2 | 3 | d = 0 | 0 | 1 | 2 | 3 | d = 0 | 0 | 1 | 2 | 3 |
| a | 0 | 3 | 2 | 1 | 0 | | 0 | 3 | 2 | 1 | | 1 | 0 | 3 | 2 | | 2 | 1 | 0 | 3 |
| | 1 | 2 | 1 | 0 | 3 | | 3 | 2 | 1 | 0 | | 0 | 3 | 2 | 1 | | 1 | 0 | 3 | 2 |
| | 2 | 1 | 0 | 3 | 2 | | 2 | 1 | 0 | 3 | | 3 | 2 | 1 | 0 | | 0 | 3 | 2 | 1 |
| | 3 | 0 | 3 | 2 | 1 | | 1 | 0 | 3 | 2 | | 2 | 1 | 0 | 3 | | 3 | 2 | 1 | 0 |
| c = 1, | | | b | | | c = 2, | | | b | | c = 3, | | | b | | c = 3, | | | b | |
| d = 1 | | 0 | 1 | 2 | 3 | d = 1 | 0 | 1 | 2 | 3 | d = 1 | 0 | 1 | 2 | 3 | d = 1 | 0 | 1 | 2 | 3 |
| a | 0 | 2 | 3 | 0 | 1 | | 1 | 2 | 3 | 0 | | 0 | 1 | 2 | 3 | | 3 | 0 | 1 | 2 |
| | 1 | 3 | 0 | 1 | 2 | | 2 | 3 | 0 | 1 | | 1 | 2 | 3 | 0 | | 0 | 1 | 2 | 3 |
| | 2 | 0 | 1 | 2 | 3 | | 3 | 0 | 1 | 2 | | 2 | 3 | 0 | 1 | | 1 | 2 | 3 | 0 |
| | 3 | 1 | 2 | 3 | 0 | | 0 | 1 | 2 | 3 | | 3 | 0 | 1 | 2 | | 2 | 3 | 0 | 1 |
| c = 1, | | | b | | | c = 2, | | | b | | c = 3, | | | b | | c = 3, | | | b | |
| d = 2 | | 0 | 1 | 2 | 3 | d = 2 | 0 | 1 | 2 | 3 | d = 2 | 0 | 1 | 2 | 3 | d = 2 | 0 | 1 | 2 | 3 |
| a | 0 | 1 | 0 | 3 | 2 | | 2 | 1 | 0 | 3 | | 3 | 2 | 1 | 0 | | 0 | 3 | 2 | 1 |
| | 1 | 0 | 3 | 2 | 1 | | 1 | 0 | 3 | 2 | | 2 | 1 | 0 | 3 | | 3 | 2 | 1 | 0 |
| | 2 | 3 | 2 | 1 | 0 | | 0 | 3 | 2 | 1 | | 1 | 0 | 3 | 2 | | 2 | 1 | 0 | 3 |
| | 3 | 2 | 1 | 0 | 3 | | 3 | 2 | 1 | 0 | | 0 | 3 | 2 | 1 | | 1 | 0 | 3 | 2 |
| c = 1, | | | b | | | c = 2, | | | b | | c = 3, | | | b | | c = 3, | | | b | |
| d = 3 | | 0 | 1 | 2 | 3 | d = 3 | 0 | 1 | 2 | 3 | d = 3 | 0 | 1 | 2 | 3 | d = 3 | 0 | 1 | 2 | 3 |
| a | 0 | 0 | 1 | 2 | 3 | | 3 | 0 | 1 | 2 | | 2 | 3 | 0 | 1 | | 1 | 2 | 3 | 0 |
| | 1 | 1 | 2 | 3 | 0 | | 0 | 1 | 2 | 3 | | 3 | 0 | 1 | 2 | | 2 | 3 | 0 | 1 |
| | 2 | 2 | 3 | 0 | 1 | | 1 | 2 | 3 | 0 | | 0 | 1 | 2 | 3 | | 3 | 0 | 1 | 2 |
| | 3 | 3 | 0 | 1 | 2 | | 2 | 3 | 0 | 1 | | 1 | 2 | 3 | 0 | | 0 | 1 | 2 | 3 |

One can see from the table that the truth table of the expression may be implemented with a switching network and a limited number of 4-state inverters, for instance as was applied in FIG. 11. In case one wants to implement the columns of the tables one needs 8 different inverters (including the unity inverter). A similar type of truth table can be generated if one puts reversible inverters on one or more of the inputs of the expression. Composite expressions in general may not be associative, and the truth table may depend on the order of input.

The radix-n or modulo-n with n>2 methods provided herein as one or more aspects of the present invention can be performed by n-valued or n-state logic devices enabled to receive, process and provide n-valued or n-state signals. One may also implement part or all of the devices in binary form, whereby n-valued signals may be represented as a plurality of binary signals also called a binary word. A binary word may be processed by binary circuitry to generate a binary word that represents an n-valued signal. One may change an n-valued signal into a binary word for instance with an A/D converter. One may also convert a binary word into an n-valued signal by applying a D/A converter. One may use as a device for transforming a first n-valued signal into another n-valued signal in accordance with an aspect of the present invention a memory device which can be applied by using an address translator to enable a memory location. Memory devices may be binary or they may be n-valued. Memory and/or switching devices may also be p-valued, wherein an n-valued signal is represented by a plurality of p-valued signals, wherein n>p>2.

The following patent applications, including the specifications, claims and drawings, are hereby incorporated by reference herein, as if they were fully set forth herein: (1) U.S. Non-Provisional patent application Ser. No. 10/935,960, filed on Sep. 8, 2004, entitled TERNARY AND MULTI-VALUE DIGITAL SCRAMBLERS, DESCRAMBLERS AND SEQUENCE GENERATORS; (2) U.S. Non-Provisional patent application Ser. No. 10/936,181, filed Sep. 8, 2004, entitled TERNARY AND HIGHER MULTI-VALUE SCRAMBLERS/DESCRAMBLERS; (3) U.S. Non-Provisional patent application Ser. No. 10/912,954, filed Aug. 6, 2004, entitled TERNARY AND HIGHER MULTI-VALUE SCRAMBLERS/DESCRAMBLERS; (4) U.S. Non-Provisional patent application Ser. No. 11/042,645, filed Jan. 25, 2005, entitled MULTI-VALUED SCRAMBLING AND DESCRAMBLING OF DIGITAL DATA ON OPTICAL DISKS AND OTHER STORAGE MEDIA; (5) U.S. Non-Provisional patent application Ser. No. 11/000,218, filed Nov. 30, 2004, entitled SINGLE AND COMPOSITE BINARY AND MULTI-VALUED LOGIC FUNCTIONS FROM GATES AND INVERTERS; (6) U.S. Non-Provisional patent application Ser. No. 11/065,836 filed Feb. 25, 2005, entitled GENERATION AND DETECTION OF NON-BINARY DIGITAL SEQUENCES; (7) U.S. Non-Provisional patent application Ser. No. 11/139,835 filed May 27, 2005, entitled MULTI-VALUED DIGITAL INFORMATION RETAINING ELEMENTS AND MEMORY DEVICES; (8) U.S. Non-Provisional patent application Ser. No. 11/427,498 filed on Jun. 29, 2006 entitled CREATION AND DETECTION OF BINARY AND NON_BINARY PSEUDO-NOISE SEQUENCES NOT USING LFSR CIRCUITS; (9) U.S. Non-Provisional patent application Ser. No. 11/534,777 filed on Sep. 25, 2006 entitled: ENCIPHERMENT OF DIGITAL SEQUENCES BY REVERSIBLE TRANSPOSITION METHODS; (10) U.S. Non-Provisional patent application Ser. No. 11/534,837 filed on Sep. 25, 2006 entitled: GENERATION AND SELF-SYNCHRONIZING DETECTION OF SEQUENCES USING ADDRESSABLE MEMORIES; (11) U.S. Non-Provisional patent application Ser. No. 11/964,507, filed on Dec. 26, 2007, entitled IMPLEMENTING LOGIC FUNCTIONS WITH NON-MAGNITUDE BASED PHYSICAL PHENOMENA.

While there have been shown, described and pointed out fundamental novel features of aspects of the present invention as applied to preferred embodiments thereof, it will be understood that various omissions and substitutions and changes in the form and details of the devices and methods illustrated and in its operation may be made by those skilled in the art without departing from the spirit of the invention. It is the intention, therefore, to be limited only as indicated by the scope of the claims appended hereto.

What is claimed:

1. A computer device for performing a multiplication of a multiplicand of at least p radix-n digits with a multiplier of at least p radix-n digits with n>2 and p≧3, comprising:
a circuit having p inputs and an output, the circuit being selected from a plurality of circuits, the circuit implementing a truth table of a modulo-n addition that is modified in accordance with the p digits of the multiplier, wherein:
each of the p inputs is enabled to receive a signal that represents a radix-n digit of the multiplicand;
none of the radix-n digits is zero;
the output provides a signal that represents a residue of a sum of p partial products of the multiplication, each of the p partial products having an identical radix-n position and no signal representing a residue of a partial product is generated to determine the signal representing the residue of the sum; and
means for selecting the circuit from the plurality of circuits based on a value of the p radix-n digits of the multiplier.

2. The device as claimed in claim 1, further comprising a second circuit having p inputs and an output, wherein:
the p inputs of the second circuit are enabled to receive the signals that represent the p radix-n digit of the multiplicand;
the second circuit implements a truth table of a modulo-n addition carry in accordance with p digits of the multiplier; and
the output of the second circuit provides a signal that represents a carry of the sum.

3. The device as claimed in claim 1, wherein a signal representing a radix-n digit is an n-valued signal that is enabled to assume one of n states.

4. The device as claimed in claim 1, wherein the first circuit is realized from at least one n-state switch.

5. The device as claimed in claim 1, wherein a signal representing a radix-n digit is comprised of a plurality of binary signals.

6. The device as claimed in claim 1, wherein the first circuit is realized from at least one binary switching component.

7. The device as claimed in claim 1, wherein the device is applied in a digital filter.

8. The device as claimed in claim 1, wherein the new state truth table implementation is applied in a Digital Signal Processor.

9. A computer device for performing a multiplication of a variable multiplicand of at least p radix-n digits with a constant multiplier of at least p radix-n digits with n>2 and p≧3, comprising:
a circuit having p inputs and an output, the circuit implementing a truth table of a modulo-n addition that is modified in accordance with p digits of the constant multiplier, wherein:
each of the p inputs is enabled to receive a signal that represents a radix-n digit of the variable multiplicand;
none of the p radix-n digits is zero;
the output provides a signal that represents a residue of a sum of p partial products of the multiplication, each of the p partial products has an identical radix-n position and no signal representing a residue of a partial product is generated to determine the signal representing the residue of the sum.

10. The device as claimed in claim 9, further comprising a second circuit having p inputs and an output, wherein:
the p inputs of the second circuit are enabled to receive the signals that represent the p radix-n digits of the multiplicand;
the second circuit implements a truth table of a modulo-n addition carry in accordance with p digits of the multiplier; and
the output of the second circuit provides a signal that represents a carry of the sum.

11. The device as claimed in claim 9, wherein a signal representing a radix-n digit is an n-valued signal that is enabled to assume one of n states.

12. The device as claimed in claim 9, wherein the circuit is realized from at least one n-state switch.

13. The device as claimed in claim 9, wherein a signal representing a radix-n digit is comprised of a plurality of binary signals.

14. The device as claimed in claim 9, wherein the circuit is realized from at least one binary switching component.

15. The method as claimed in claim 8, wherein the device is applied in a digital filter.

16. A method for performing with a computing device a multiplication of a variable multiplicand of at least p radix-n digits with a constant multiplier of at least p radix-n digits with n>2 and p≧3, comprising:
inputting on each of p inputs of a circuit a signal representing a digit of the variable multiplicand, wherein the circuit implements a modulo-n addition modified in accordance with p radix-n digits of the constant multiplier and none of the p radix-n digits of the multiplicand and the multiplier is zero;
outputting on an output of the circuit a signal that represents a residue of a sum of p partial products of the multiplication, each of the p partial products has an identical radix-n position and no signal representing a residue of a partial product is generated to determine the signal representing the residue of the sum.

17. The method as claimed in claim 16, further comprising:
inputting on p inputs of a second circuit the signals representing the digits of the variable multiplicand, wherein the second circuit implements a modulo-n addition carry truth table in accordance with p radix-n digits of the constant multiplier;
outputting on an output of the second circuit a signal that represents a carry of the sum and no signal representing a residue of a partial product is generated to determine the signal representing the carry of the sum.

18. The method as claimed in claim 16, wherein a signal representing a radix-n digit is an n-valued signal that is enabled to assume one of n states.

19. The method as claimed in claim 16, wherein a signal representing a radix-n digit is comprised of a plurality of binary signals.

20. The method as claimed in claim 16, wherein the multiplication is performed as part of implementing a digital filter.
